(19) United States
(12) Patent Application Publication
(10) Pub. No.: US 2022/0329909 A1
(43) Pub. Date: Oct. 13, 2022

(54) INTERACTIVE MULTIMEDIA MANAGEMENT SYSTEM TO ENHANCE A USER EXPERIENCE AND METHODS THEREOF

(71) Applicants: Gabriel Ramirez Juan, Guaynabo, PR (US); Mariana Margarita Emmanuelli Colon, Caguas, PR (US)

(72) Inventors: Gabriel Ramirez Juan, Guaynabo, PR (US); Mariana Margarita Emmanuelli Colon, Caguas, PR (US)

(21) Appl. No.: 17/642,526

(22) PCT Filed: Sep. 15, 2020
(86) PCT No.: PCT/US20/50785

§ 371 Date: Mar. 11, 2022

Related U.S. Application Data
(60) Provisional application No. 62/899,179, filed on Sep. 12, 2019.

(51) Int. Cl. H04N 21/4725; H04N 21/478; H04N 21/414; H04N 21/658; H04N 21/81

(52) U.S. Cl. CPC H04N 21/4725; H04N 21/47815; H04N 21/41407; H04N 21/6582; H04N 21/812

(57) ABSTRACT

A system and methods is provided for converting visual, audio and/or other forms of sensory content & experiences that include items representing people, animals, objects, locations, products, services, organizations, events, textual information, etc. into interactive media that is used for accessing and saving data and information, obtaining additional content and for exercising further actions. A centralized platform provides individual and collective management of data, content and actions associated to the various types of users of the system.

### FIELD OF INVENTION

The present invention is directed towards a system and method for retail, advertising, media, education and entertainment. More specifically the invention relates to enabling a viewer to quickly and easily capture, anytime and anywhere, information associated to an item of interest that is shown in or alluded to by visual, audio and/or other forms of sensory content or experiences so as to support subsequent actions such as a purchase or the garnering of further information.

### BACKGROUND OF THE INVENTION

The growing presence of the media and entertainment industry in the daily lives of most societies is unquestionable, as is the value of its global reach which is fundamental for the international economy; especially if we take into account its relation to retail. Comprised of businesses that among other things develop and distribute motion pictures, digital and television commercials and programs, advertising, streaming content, music and audio recordings, broadcast, book publishing, video games and supplementary services and products, it undeniably serves modern human expression and greatly influences economic and cultural tendencies. And just like for many other industries, the evolution of technology has caused a dramatic shift in the way businesses and artists approach the industry, as well as how people interact with and consume its products. Rapid accessibility is a big issue now since acquiring content is not so much a question of if, but instead a question of when and how. And with these expectations also comes a demand by consumers and businesses for innovative experiences that they require media and entertainment companies to deliver.

In tune with these expectations, companies have found new ways to deliver experiences; most notably for our purposes is interactive media. Interactive media references products and services on digital computer-based systems that provide a response to a user's actions; like a click, a swipe, data input, etc. And it may be any response, including but not limited to, presenting content such as text, images, video, audio, animations or games; redirecting to other web pages or documents; or saving data. Yet the way that these responses are carried out may vary quite dramatically and depending on the methods chosen the effect can be either detrimental or beneficial for the experience. Nevertheless, this interchange tends to have great value since it allows for a two-way communication channel that, unlike the one-sided non-interactive media, provides something for all the parties involved; including for content providers, which incentivize interaction in order to receive something in return (usually valuable data). For this reason, its use has grown exponentially.

With this in mind, many companies nowadays implement interactive strategies. Yet limitations on its use are still abundant. First, traditional media (cinema, television, print, radio, traditional advertising and billboards) has for the most part been excluded from interactive implementations. Albeit with the transition to digital, attempts to create interactivity in this traditional media have occurred, but lack efficiency, swiftness, organization and control for consumers. An example that can be mentioned is the ability to purchase items from a digital television utilizing the remote control, which provides a slow and restricted experience.

A second limitation is the lack of control given to the consumers. Be it digital or traditional, the timing of an optional interaction tends to be decided by the content provider instead of the consumers; by limiting accessibility and further actions by the consumers afterwards. For example, nowadays people are increasingly exposed to interactive media, and with smartphones' usage growing at an extremely quick pace, access to this media is ever growing and attainable from a widespread of locations. Nevertheless, certain interactions may be inconvenient or impossible, depending on the consumer's current location and activity. One example would be if a consumer wants to purchase an item he or she sees on an interactive ad, then he or she risks losing access or finding the item again if purchase is not done at the moment the interactive ad is viewable; yet the location or situation the viewer is in, such as in an office meeting or restaurant, may prove improper or uncomfortable to make a proper purchase decision at that precise time and might warrant further consideration by the potential customer. Yet, if the viewer does not purchase at that moment, or cannot save the item's information, there will be a prolonged delay between the time when he or she is initially shown the advertising and acquires interest for the product or service, and the time where he or she can truly have the opportunity to act upon that interest. When the opportunity to purchase the product or service does finally arrive, the impulse to purchase may have diminished or he or she may not even remember who the advertiser was, or the details about the product or service that he or she wished to purchase. Consequently, the sale may be lost because the immediacy of the information and the interest developed has diminished or now the purchase proves too difficult to implement.

Third, another limitation on current interactive processes is diversification of use. Interactive offerings usually cater to one media outlet and do not offer the capability to interact with multiple media through one single system or mechanism. For example, an interactive ad may be shown on your TV or through your mobile browser, but current processes complicate things by requiring different devices for interacting with content shown in different media outlets; therefore people could only interact with the ad shown on the tv, by means of the television or through a related device like its remote control, and with the ad shown through the mobile browser by utilizing a smartphone. This leads to the need of multiple devices for very similar functions.

Furthermore, a fourth limitation that can be observed is organization. Available interactive options do not provide consumers with the capability to organize the value received from all interactions into one single place for reference, evaluation or further resulting actions.

Therefore, what is needed is a system and methods that provide an integral and centralized multimedia platform that allows individuals and collective interactions and exchange of data among the various users. The proposed system and methods overcome the above-mentioned disadvantages allowing for diversification of use, better organization and more consumer control, that can easily be implemented for visual, audio and/or other forms of sensory content or experiences thus allowing for better interactions.

### SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be to present some innovations, embodiments, and/or examples found within this disclosure in a simplified form as a prelude to a more detailed description presented later.

If we consider advertising, we can perceive that in many cases it follows an incomplete methodology based on assumptions that don't accurately justify investment, nor adequately translate to sales. For example, presently brands pay significant amounts on advertising to ultimately sell their products, yet most ads lack direct and easy purchase options, and appropriate measurements of effectiveness. Additionally, current strategies aren't very effective at converting viewers, listeners, or overall experiencers that weren't ready to purchase when they saw, heard or experienced the ad; mostly because of the inconvenience of finding the products afterwards or the time required to complete the purchase. This translates into brands losing out on a significant portion of potential customers because accessibility to the products was not made quick nor convenient. By presenting a system that provides direct and traceable points of sales, data analytics, easy purchase options, plus convenient and accessible means to promoted or advertised products, these flaws within the advertisement industry can be corrected and may even result in the completion of the aforementioned methodology by consolidating this industry with the retail industry. Such a system may also improve entertainment, education and other industries by redirecting some of its functions to enhance the overall interactions that individuals may have with visual, audio and/or other forms of sensory content or experiences.

In various embodiments, a system and method are provided for converting visual, audio and/or other forms of sensory content & experiences into interactive mediums that can be used for accessing and saving information, obtaining additional content and for exercising further actions such as purchases. Items included or alluded to by visual, audio and/or other forms of sensory content or experiences may be representations of or mentions or allusions to people, animals, objects, locations, products, services, organizations, events, textual information, etc. In some respects, items may be identified in real time and presented in a centralized platform or mobile application for consumers to interact with and/or collect related information. Accordingly, consumers may interact with these items in a way that the device elicits a response which may include capturing and collecting item detailed information. For consumers, item detailed information may be readily accessible through a customized single access place that allows them to implement a corresponding action in accordance to the item, such as, but not limited to, a quick and convenient purchase, obtain relevant information or access new entertainment content.

Additionally, the system may include a platform that certain users may utilize to create references or references content. Each reference content may correspond to at least one item represented in visual, audio and/or other forms of sensory content or experiences. These references content may be stored in a repository or database (e.g., server database and/or reference database) which the device may communicate with, either directly or indirectly, to achieve the identification of the corresponding items presented in the visual, audio and/or other forms of sensory content or experiences. Furthermore, the platform may allow certain users to add detailed or related information about the items represented by the references content. Accordingly, each detailed or related information may be associated to at least one of the corresponding reference contents.

Detailed or related information may include product specifications (like clothing size, color, manufacture, brand, etc.), prices, delivery options, locations, biographies, filmographies, movie trailers, Behind-the-scenes, deleted scenes, post-credits scenes, directors' cuts and any other additional content.

In another aspect, data and/or analysis for each consumer interaction with the items presented in the contents or experiences may be provided to certain users, either in the platform, via a Reference Tool or Module or by other means. Consumer interaction may include clicking, collecting, saving and deleting items; purchasing products; playing, viewing and pausing videos; submitting information, etc.

A further understanding of the nature of and equivalents to the subject matter of this disclosure (as well as any inherent or express advantages and improvements provided) should be realized in addition to the above section by reference to the remaining portions of this disclosure, any accompanying drawings, and/or the claims if any.

### BRIEF DESCRIPTIONS OF THE DRAWINGS

In order to reasonably describe and illustrate those innovations, embodiments, and/or examples found within this disclosure, reference may be made to one or more accompanying drawings. The additional details or examples used to describe one or more accompanying drawings should not be considered as limitations to the scope of any of the claimed invention, any of the presently described embodiments and/or examples, or the presently understood best mode of any innovations presented within this disclosure.

FIG. 1 illustrates a system overview of a system and method according to an embodiment of the invention, for converting visual, audio and/or other forms of sensory content & experiences into interactive mediums that can be used for accessing and saving information, obtaining additional content and for exercising further actions such as purchases.

FIG. 2 shows an overview of an example of the process for uploading and storing Content 101, selections, outcomes and detailed information into Server Database 108.

FIG. 2a is an illustration of one example of an interface for Reference Tool or Module 102 embodied in a SaaS platform, with an upload or input tab opened.

FIG. 2b is an illustration of one example of an interface for Reference Tool or Module 102, embodied in a SaaS platform, with an upload or input tab opened and with Content 101 inputted.

FIG. 2c is an illustration of one example of an interface for Reference Tool or Module 102, embodied in a SaaS platform, with an upload or input tab opened and a noncompliance warning notification for a rejected Content 101.

FIG. 2d is an illustration of one example of an interface for Reference Tool or Module 102, embodied in a SaaS platform, showing all campaigns and with a Content 101 undergoing Automatic Selection Module 105.

FIG. 2e is an illustration of one example of an interface for Reference Tool or Module 102, embodied in a SaaS platform, with Campaign A opened and a Content 101 undergoing Automatic Selection Module 105.

FIG. 2f is an Illustration of one example of an interface for Reference Tool or Module 102, embodied in a SaaS platform, with Content 101 undergoing Designation Module 107 for assigning outcomes to selections.

FIG. 2g is an illustration of one example of an interface for Reference Tool or Module 102, embodied in a SaaS platform, with Content 101 undergoing Designation Module 107 for inputting detailed information.

FIG. 2h is an illustration of one example of an interface for Reference Tool or Module 102, embodied in a SaaS platform, showing an option for submitting or exporting interactive content.

FIG. 3 illustrates a simplified overview of an example of the process for Content 101 undergoing Selection Check and Manual Selection Module 106.

FIG. 3a is a visual example of the process for Content 101 undergoing Selection Check and Manual Selection Module 106 for visual content.

FIG. 3b is a visual example of the process for Content 101 undergoing Selection Check and Manual Selection Module 106 for audio content.

FIG. 4 illustrates an overview of one example of a real time item identification system for visual content displayed outside of the device being used.

FIG. 4a illustrates the use of a smartphone to identify an item of interest from a visual content displayed outside the device.

FIG. 4b illustrates a user experience when identifying an item of interest from visual Content Outside Device 112 using a smartphone as Device 110.

FIG. 5 illustrates an overview of one example of a method for capturing or saving information from visual content displayed outside of the device being used.

FIG. 5a illustrates the use of a smartphone to capture or save information of items from a visual content displayed outside the device being used.

FIG. 5b illustrates a user experience when capturing or saving information of items from a visual Content Outside Device 112 using a smartphone as Device 110.

FIG. 6 is an overview of an example of two methods for capturing or saving information of items from a visual content being played by the device in use.

FIG. 6a illustrates the process for utilizing a smartphone as Device 110 to identify and capture or save an item of interest from visual content played by the device in use.

FIG. 6b illustrates the process for utilizing a smartphone as Device 110 to capture or save an item of interest from a visual Exported Content/Selections 116 played by the device in use.

FIG. 7 illustrates an overview of one example of a real time item identification system for audio content played outside of the device being used.

FIG. 7a illustrates the use of a smartphone as Device 110 to identify items from audio Content Outside Device 112.

FIG. 8 is an overview of one example of a method for capturing or saving information from audio content displayed outside of the device being used.

FIG. 8a illustrates capturing or saving items from an audio Content Outside Device 112 using a smartphone as Device 110.

FIG. 9 illustrates an overview of an example of two methods for capturing or saving information of items from an audio content being played by the device in use.

FIG. 9a illustrates the process for utilizing a smartphone as Device 110 to identify and capture or save an item of interest from audio content played by the device in use.

FIG. 9b illustrates the process for utilizing a smartphone as Device 110 to capture or save an item of interest from an audio Exported Content/Selections 116 played by the device in use.

FIG. 10 illustrates an overview of one example of the process for accessing the user of Interactive App 111's item list.

FIG. 10a illustrates the process for accessing the user of Interactive App 111's item list from different devices.

FIG. 11 illustrates an Interactive App 111's interface displaying an items list.

FIG. 12 illustrates an Interactive App 111's interface displaying a purchase tab.

FIG. 13 illustrates one example of a system and method for collecting data from interactions made by users of Interactive App 111 and making it accessible to users of Reference Tool or Module 102.

FIG. 13a illustrates the use of a user interface like a dashboard to present the system and method for users of Reference Tool or Module 102 to view data analytics.

FIG. 14 illustrates the proposed system used in a collective scenario.

FIG. 15 illustrates an interactive catalogue displayed on visual content.

Throughout the figures, the same reference numbers and characters, unless otherwise stated, are used to denote like elements, components, portions or features of the illustrated embodiments. The subject invention will be described in detail in conjunction with the accompanying figures, in view of the illustrative embodiments.

### DETAILED DESCRIPTION OF THE INVENTION

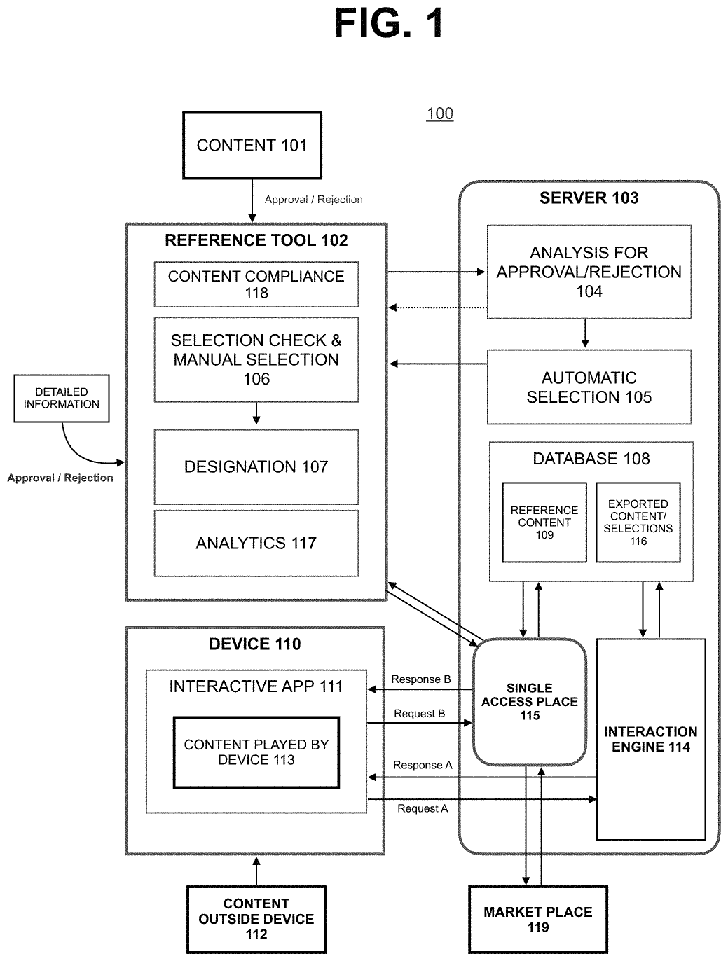

One or more solutions to providing a system and methods for converting visual, audio and/or other forms of sensory content & experiences into interactive mediums that can be used for accessing and saving information, obtaining additional content and for exercising further actions such as purchases are described according to FIG. 1 which is an illustrative embodiment or implementation of an invention disclosed herein and should not limit the scope of any invention as recited, presented, explained or detailed in this whole disclosure. One of ordinary skill in the art may recognize through this disclosure and the teachings presented herein other variations, modifications, and/or alternatives to those embodiments or implementations illustrated in the figures.

According to a preferred embodiment of invention, FIG. 1 illustrates a system overview of System 100 where it is shown a system and methods for converting visual, audio and/or other forms of sensory content & experiences into interactive mediums that can be used for accessing and saving information, obtaining additional content and for exercising further actions such as purchases, in one embodiment according to the present invention. As per this embodiment, System 100 may be implemented by means of, on and/or within a network of computerized systems connected by physical and/or wireless connections.

According to this embodiment, System 100 begins with the upload or input of Content 101 utilizing Reference Tool or Module or Module 102 (illustrated in FIG. 1 with an arrow going from Content 101 to Reference Tool or Module 102). Content 101 (or parts of it) may represent anything for which the uploader of Content 101 wants to make interactive. For example, Content 101 (or parts of it) may depict items, objects, people, places, companies, music, sounds, phrases, locations, scenes, credits, products, services, etc. In some embodiments of the invention, Content 101 may take the form of (but not limited to) a file, such as an audio, image or video file, a URL or a link that the user inputs, provides or uploads using Reference Tool or Module or Module 102. And it may include image data, video data, audio data, textual data, metadata, numerical data, symbols, computer or program code or language, or an audio/visual/sensory representation of the like and any such information or combination of.

In another aspect of the invention, Reference Tool or Module 102 may be used to make Content 101 (or parts of it) interactive. As per this example, the Reference Tool or Module 102 may be used to upload, transfer or input Content 101 into Server 103. Under this consideration Reference Tool or Module 102 may also provide an automatic or manual verification process for approving or rejecting Content 101 based on quality, format, size of file, resolution, file type or any other criteria required of Content 101 to be supported by System 100 illustrated in FIG. 1 as Content Compliance 118. With respect to this, and in some embodiments, if Content 101 is rejected, a “noncompliance warning” or “error” may be presented to the user of Reference Tool or Module 102 requiring the correction of certain criteria to proceed or conversely the process may simply just be detained and require a restart with a Content 101 that complies with the appropriate criteria.

Contrarily, if approval is met, Reference Tool or Module 102 may proceed with the upload, transfer, or input of Content 101 into Server 103. In another aspect of the invention, Reference Tool or Module 102 may be used to verify results of Automatic Selection Module 105 (as discussed further below under Automatic Selection Module 105) and/or select all or parts of Content 101 by means of Selection Check and Manual Selection Module 106 (as discussed further below under Selection Check and Manual Selection Module 106). In yet another aspect of the invention, Reference Tool or Module 102 may be used to input, upload, transfer, select and/or assign outcomes and detailed information by means of Designation Module 107 (as discussed further below under Designation Module 107). Furthermore, in another aspect of the invention, it may be used to export Exported Content/Selections 116 (as discussed further below under Exported Content/Selections 116). Also, in another aspect of invention, it may be used to access data and/or analytics by means of Analytics Module 117 (as discussed further below under Analytics Module 117). In addition to the aforementioned functionalities, in another aspect of invention, Reference Tool or Module 102 may also include or provide access to one or more user interfaces that may allow users to create, authenticate, log into, log out of, edit and/or maintain an account.

According to at least some embodiments of the invention, Reference Tool or Module 102 may also provide users with the capacity to organize their uploads or inputs (including Content 101, selections, detailed information and/or outcomes) within their accounts and/or save, access, store, change, search, modify, define, control, retrieve, create, manipulate, delete, edit, activate, deactivate, update, manage and/or maintain any of them before, during and/or after any of the processes described above. In at least some embodiments of the invention, all these functions may occur with the assistance of a database management system (as explained further below under Single Access Place or Module 115). One example of organization may be for Content 101 (or parts of it) to be sorted or organized in campaigns, categories, groups, folders or the like.

In some embodiments of the invention, Reference Tool or Module 102 may take the form of a web page, website, web application, web-based Tool or Module, a dashboard, online Tool or Module, SaaS platform, native application, software, and/or any type of Tool or Module, application or site, and the like.

In another aspect of this invention, System 100 (or parts of it) may run or function by means of a client-server architecture, thus some embodiments may allow for one or multiple servers, computer or server clusters, computerized programs and processes and/or devices to be used to run, assist, communicate, share resources and data, interact with and/or provide overall functionality to System 100 and/or any of its components. For illustrative purposes, FIG. 1 illustrates one embodiment with a Server 103. As per this embodiment, Server 103 may provide database services, computer vision services, machine learning services, storage and sharing services (for files, media, audio), network services, communication services, computing services, catalog services, sound server services, proxy server services, virtual server services, mail server services, print server services, web server services, gaming services, application services and any such Tool or Module needed to accomplish the functions and services attributed herein to Server 103. Yet in other embodiments of this invention, System 100 (or parts of it) may run or function by means of a peer to peer architecture to accomplish similar objectives.

Furthermore, in some embodiments of the invention, Server 103 may provide and/or manage all of the functionalities of the components presented within it in FIG. 1. Yet for other embodiments of the invention, some of these functionalities may be outsourced. For the purpose of clarity, these functionalities have been labeled as Analysis for Approval/Rejection Module 104, Automatic Selection Module 105, Server Server Database 108, Interaction Engine or Module 114 and Single Access Place or Module 115.

Referring again to FIG. 1, in another aspect of this invention, when Content 101 is uploaded, inputted and/or transferred utilizing Reference Tool or Module 102 (and approved by Reference Tool or Module 102), it may be automatically verified through one or more processes such as Analysis for Approval/Rejection Module 104. As per this embodiment, Analysis for Approval/Rejection Module 104 may determine if Content 101 complies with the requirements of Automatic Selection Module 105, Selection Check and Manual Selection Module 106 and Reference Content 109. Among the requirements considered by Analysis for Approval/Rejection Module 104, may be security factors, defining characteristics, uniqueness, quality, type of content, format, size of file, resolution, file type, volume, distinguishability, etc.

In another embodiment of the invention, when Content 101 is approved by Analysis for Approval/Rejection Module 104, Content 101 is stored in Server Server Database 108 and Automatic Selection Module 105 automatically initializes, or the ability to manually start it may be granted. In another embodiment of the invention, when Content 101 is approved by Analysis for Approval/Rejection Module 104 and stored in Server Server Database 108 by means of Reference Tool or Module 102, Automatic Selection Module 105 may be bypassed and Selection Check & Manual Selection Module 106 may be initiated as the next step in the system. In yet another embodiment of the invention, when Content 101 is approved by Analysis for Approval/Rejection Module 104 and stored in Server Server Database 108 by means of Reference Tool or Module 102, Automatic Selection Module 105 and Selection Check & Manual Selection Module 106 may be bypassed and access to Designation Module 107 may be granted; for example when it is intended and possible for Content 101 to serve as Reference Content 109, “as is”, in its totality as one selection (as explained further below under Automatic Selection Module 105). In most embodiments of this invention, when Content 101 is rejected by Analysis for Approval/Rejection Module 104, a “noncompliance warning” or “error” may be presented to the user of Reference Tool or Module 102 requiring the correction of certain criteria to proceed, may simply just be detained and require a restart with a Content 101 that complies with the appropriate criteria. This rejection warning or error may or may not provide specifications on what needs to be corrected. In some embodiments of the invention, Analysis for Approval/Rejection Module 104 may take the form of a processing engine or unit, or any other component, program, application or software capable of receiving image, audio and/or sensory data from Reference Tool or Module 102.

In regard to the above explained, it must be noted that in certain embodiments of this invention, when Content 101 is uploaded, inputted and/or transferred utilizing Reference Tool or Module 102 (and approved by Reference Tool or Module 102), the possibility that Content 101 may be preliminarily and/or temporarily stored in Server Database 108 before going through Analysis for Approval/Rejection Module 104 may exist. As per this example, if Content 101 is approved by Analysis for Approval/Rejection Module 104, it may stay stored in Server Database 108 and continue with the process, but if rejected it may be deleted from Server Database 108 thus preventing the continuation of the process.

In another aspect of the invention, Automatic Selection Module 105 may, in some embodiments, automatically initialize, or may be manually initiated when Content 101 is approved by Analysis for Approval/Rejection Module 104. For some embodiments of this invention, Automatic Selection Module 105 may consist of one or more processes or Tool or Modules that automatically identify and select all or parts of Content 101 for the purpose of creating Reference Content 109 (as described further below under Reference Content 109).

As per this embodiment, Automatic Selection Module 105 may identify letters, numbers, symbols, image data, video data, audio data, textual data, metadata, numerical data, snapshots, computer or program code or language, frame, or any audio/visual/sensory representation of the like and any such information or combination of that may constitute all or part of Content 101 and select what complies with the requirements needed to serve as Reference Content 109. Additionally, as per this example, selections may represent items, objects, people, places, companies, music, sounds, phrases, locations, scenes, credits, products, services, or anything that may be distinguishable, detectable and may be used for the purposes described under Designation Module 107 and/or Reference Content 109. Also, as per this embodiment, these selections may constitute the entirety of the uploaded Content 101 or parts of it. Furthermore, in some embodiments, the selections made by Automatic Selection Module 105 may directly be used to serve as Reference Content 109. Yet in other embodiments, it may be required for users of Reference Tool or Module 102 to approve or check these selections in order for them to serve as Reference Content 109 (as described under Selection Check & Manual Selection Module 106).

Referring again to FIG. 1, in another aspect of the invention, Selection Check & Manual Selection Module 106 may, in some embodiments, be accessible by users of Reference Tool or Module 102 when Automatic Selection Module 105 has completed the process or processes for automatic selection (illustrated in FIG. 1 with an arrow going from the component 105 to 106). In other embodiments, Selection Check & Manual Selection Module 106 may be accessible by users of Reference Tool or Module 102 directly when Content 101 is approved by Analysis for Approval/Rejection Module 104, therefore bypassing or running simultaneously with Automatic Selection Module 105 (illustrated in FIG. 1 with a dashed arrow going from the component 104 to 106). As per this embodiment, Selection Check & Manual Selection Module 106 may comprise of one or more processes or Tool or Modules that allow users of Reference Tool or Module 102 to check, select, deselect and/or approve or reject Automatic Selection Module 105's selections. Also, as per this embodiment, Selection Check & Manual Selection Module 106 may also comprise of one or more processes or Tool or Modules that allow users of Reference Tool or Module 102 to manually make selections of Content 101. In some embodiments, making selections by means of Selection Check & Manual Selection Module 106 may constitute the same considerations, descriptions and/or factors as explained in this document for Automatic Selection Module 105; except that in Selection Check & Manual Selection Module 106 the selection process is done manually and may also entail verification, approval or rejection of the selections made by Automatic Selection Module 105.

Referring to FIG. 1, in another aspect of the invention, Designation Module 107 may be used to assign outcomes and detailed information to the selections by means of Reference Tool or Module 102. Accordingly, this process may include, but is not limited to uploading, inputting, selecting, submitting and/or transferring commands, actions and/or information to Server 103 (more specifically Server Database 108). Depending on the embodiment that is used, Designation Module 107 may be automatic or manual.

As per this embodiment, outcomes and detailed information are designated for the purpose of providing a desired result to users of Interactive App 111, like showing an image or video, providing access to information or additional content, options for saving an item and/or purchasing a product, among other possibilities. Examples for these outcomes may be, but are not limited to, visual, audio and/or sensory experiences including presenting augmented reality experiences, displaying videos, showing images, playing music, producing sounds and/or voice responses and providing haptic experiences like vibrations. Other examples of outcomes may include actions like saving, purchasing, sharing, reserving, etc. In some embodiments, certain outcomes may provide the possibility for interactions like clicking, pressing, tapping, swiping, gesturing, voice commanding, etc. to produce additional desired outcomes.

Additionally, as per this embodiment, detailed information represents the information and/or content users of Reference Tool or Module 102 want to present or make accessible with the outcomes. Examples of detailed information may include product/service information or specifications (such as brand, product/service name, manufacturer, model number, color, size, type, title, description, keywords, images, prices, product/service options, delivery options, shipping details, etc.), locations, biographies, filmographies, movie trailers, behind-the-scenes, deleted scenes, post-credits scenes, directors' cuts and any other additional content. Similar to Content 101, detailed information may take the form of (but not limited to) a file, such as an audio, image or video file, a URL or a link; and it may include image data, video data, audio data, textual data, metadata, numerical data, symbols, computer or program code or language, or an audio/visual/sensory representation of the like and any such information or combination thereof.

Moreover, users of Reference Tool or Module 102, by means of Designation Module 107, may assign a single outcome or multiple outcomes to the same selection. An example of this may be if a single selection displays multiple items, (like a movie scene presenting within the same frame a character, its outfit and a location) to which users of Reference Tool or Module 102 assign separate outcomes for each item. For example, the character or actor may be assigned an outcome that supplies more information about the actor when interacted with; the outfit that the character is wearing may be assigned an outcome that supplies purchasing options; and the location (e.g. a restaurant) may be assigned an outcome that supplies reservation options. On the other hand, even if a selection represents multiple items, users of Reference Tool or Module 102 may opt to assign only one outcome for the entire selection. An example of this may be if Content 101 is a movie poster and a user of Reference Tool or Module 102 selects the entirety of Content 101 as a selection in order to assign an outcome that displays the trailer of the movie that's being advertised in the poster. Furthermore, as per this example, the same user of Reference Tool or Module 102 may later opt to edit this outcome and assign additional multiple outcomes to the items presented within the movie poster.

Moreover, in some embodiments of the invention, Designation Module 107 may provide the possibility of placing and/or listing the products, services, items, content and/or any other detailed information on a digital marketplace (or any other type of e-commerce) that can be accessed by users of Interactive App 111 (as described further below under Interactive App 111). Depending on the embodiment that is used, this process may be automatic or manual.

Also, in some embodiments of the invention, when detailed information is inputted by means of Designation Module 107, Reference Tool or Module 102 may require and provide an automatic or manual verification process (similarly to the one discussed under Reference Tool or Module 102 for Content 101) for approving or rejecting detailed information based on quality, format, size of file, resolution, file type or any other criteria required of detailed information to be supported by System 100 (illustrated in FIG. 1 as “Approval/Rejection” between DETAILED INFORMATION and Reference Tool or Module 102). If rejected, a “noncompliance warning” or “error” may be presented to the user of Reference Tool or Module 102 requiring the correction of certain criteria to proceed or may simply just detain the process and require a different detailed information that complies with the appropriate criteria. However, if approval is met, Reference Tool or Module 102 may proceed with the upload, transfer, or input of detailed information into Server 103.

Likewise, in some embodiments, when detailed information is uploaded, inputted and/or transferred utilizing Reference Tool or Module 102 (and approved by Reference Tool or Module 102), it may also be automatically verified through one or more processes such as Analysis for Approval/Rejection Module 104, so it may determine if information complies with the requirements needed to serve as detailed information. As previously explained, among the requirements considered by Analysis for Approval/Rejection Module 104, may be security factors, defining characteristics, uniqueness, quality, type of content, format, size of file, resolution, file type, volume, distinguishability, etc. Furthermore, in some embodiments of the invention, when detailed information is rejected by Analysis for Approval/Rejection Module 104, a “noncompliance warning” or “error” message may be presented to the user of Reference Tool or Module 102 requiring the correction of certain criteria related to Designation Module 107 before permission to proceed is granted, or the process may simply be stopped and a different detailed information that complies with the appropriate criteria may be required. This “rejection warning” or “error” message may or may not provide specifications on what needs to be corrected. If approval is obtained, uploaded detailed information may be stored, saved and/or maintained in Server 103, or in any type of repository (as described under Server Database 108) that Server 103 may communicate with and/or obtain data from and/or send data to.

In addition, for some embodiments, Designation Module 107 may require users of Reference Tool or Module 102 to manually submit or save outcomes and detailed information into Server 103 in order to complete the process of assigning them. In other embodiments, Reference Tool or Module 102 may automatically (continually or systematically) submit or save the inputted outcomes and detailed information into Server 103 either during the process or after its completion.

As illustrated in FIG. 1, and in some embodiments of this invention, Content 101, selections, outcomes and detailed information, as well as Reference Content 109 (explained below), profile and account information (for both Reference Tool or Module 102 and Interactive App 111), and data produced for Analysis Module 117 (as explained further below under Analysis Module 117), may be stored, saved and/or maintained in one or more repositories such as a database so that they can be accessed by the Reference Tool or Module 102 and/or the Interactive App 111 (as discussed further below under Single Access Place or Module 115). Furthermore, these repositories may be a component of Server 103, or may also be any type of repository outside Server 103 that Server 103 may communicate with and/or obtain data from and/or send data to. One example of this may be a database running within Server 103, which for the purpose of clarity has been labeled in FIG. 1 as Server Database 108.

As per this example, and in some embodiments of invention, users of Reference Tool or Module 102 may access Server Database 108 for the purpose of, but not limited to, accessing their profile account information; creating, updating, managing and/or completing processes with stored Content 101, selections, outcomes, detailed information and Reference Content 109; exporting content (as explained further below under Exported Content/Selections 116); and/or viewing and retrieving data analytics as described further below under Analytics Module 117. In some embodiments of the invention, all these functions may occur with the assistance of a database management system (as discussed below under Single Access Place or Module 115).

Also as per this example, and in some embodiments, Interactive App 111 may access Server Database 108 for the purpose of, but not limited to, providing users of Interactive App 111 with their account information as well as with the outcomes and detailed information stored and assigned by means of Designation Module 107 (as described under Interactive App 111). Accordingly, Interaction Engine Module 114 & Single Access Place Module 115 may be used to access Server Database 108 (as described under Interactive Engine Module 114 & Single Access Place Module 115).

In some embodiments of the invention, selections may be stored, saved and/or maintained in Server Database 108 by users of Reference Tool or Module 102 with the purpose of establishing matching references for triggering designated outcomes (as discussed further below under Request A and Interaction Engine Module 114). For the purpose of clarity, these matching references have been labeled in FIG. 1 as Reference Content 109. As per this example, this may occur before, during, and/or after Designation Module 107 and may be automatic or manual. Also, as per of this example, what constitutes Reference Content 109 will depend on the processes exercised by the users of Reference Tool or Module 102 and the embodiment of the invention that is in place. In some embodiments of the invention, selections made by Automatic Selection Module 105 and/or Selection Check & Manual Selection Module 106 (following the processes previously described) may be stored, saved and/or maintained in Server Database 108 as Reference Content 109. Depending on the embodiment that is used, selections may constitute all or parts of Content 101 (as established under Automatic Selection Module 105). In other embodiments of the invention, it may be possible for Content 101, as a whole and without selections, to be what serves as Reference Content 109. This may occur if the embodiment in place allows for Content 101 to be directly stored, saved and/or maintained as Reference Content 109 immediately after receiving an approval by Analysis for Approval/Rejection Module 104 and without going through a selection process (like Automatic Selection Module 105 and/or Selection Check & Manual Selection Module 106). As established under Server Database 108, in some embodiments, Reference Content 109 may be accessed, stored, changed, searched, modified, defined, controlled, retrieved, created, manipulated, deleted, edited, activated, deactivated, updated, managed and/or maintained by users of Reference Tool or Module 102.

As shown in FIG. 1, in some embodiments of the invention, Device 110 may represent a device, apparatus and/or equipment that can read, detect, sense, capture, receive, interpret and/or respond to Content Outside Device 112 (as defined further below under Content Outside Device 112), and transmit, link, convey and/or communicate these readings, detections, perceptions, sensations, captures, receptions and/or interpretations to Interactive App 111. Furthermore, in some embodiments, Device 110 may represent a device, apparatus and/or equipment that can display, play, project, emit, and/or execute (convey) Content Played by Device 113 (as defined further below under Content Played by Device 113), as well as read, detect, sense, capture, receive, identify, interpret and/or respond to Content Played by Device 113, and transmit, link and/or communicate these readings and/or any other data produced by said actions to Interactive App 111 to convey information to the user. In yet other embodiments, Device 110 may be a combination of both. Additionally, for some embodiments, users of Device 110 may be able to enable and/or disable some or all these functionalities. For the purpose of the present invention, the terms “convey”, “conveying” and “conveyed” are interchangeably used to include any means available the allows the system to show information/data regardless if it is a visual, audible, tactile, etc. . . . media.

As per the above examples, Device 110 may be any type of device, apparatus and/or equipment (portable or non-portable) such as, but not limited to, a smartphone, tablet, laptop computer, desktop computer, television display, monitor, VR equipment, AR equipment, glasses, lenses, neural device, smartwatch and/or computing device and/or electronic device.

In some embodiments of the invention, Device 110 may be a device, apparatus and/or equipment (portable or non-portable) that houses, hosts, holds and/or supports Interactive App 111 as shown in FIG. 1. In other embodiments, Device 110 may be a separate device, apparatus and/or equipment (portable or non-portable) that doesn't house, host, hold and/or support Interactive App 111 but still can transmit, link and/or communicate the readings, detections, captures, receptions and/or interpretations mentioned above to Interactive App 111. In yet other embodiments, Device 110 may be a combination of both. An example of this may be if a user of Interactive App 111 uses the combination of smart glasses and a smartphone as Device 110, so that user may capture Content Outside Device 112 with the glasses and access the captured content by using the smartphone housing the Interactive App 111. Device 110 can include a location module such as but not limited to GPS, WiFi, Satellite, or any other internal or external module that can provide to the system and/or Interactive App 111 information related to the location (e.g., latitude, longitude) of the user and/or Device 110. This location information can be used in conjunction with other information according to the invention, to enhance the experience of the user. For example, if a user interacts with a movie stream within the Device 110 the system can provide the user with the option of buying movie tickets and a list of the closest movie theaters based on the determined location of the Device 110. Of course, this location functionality can also be implemented in other embodiments of the invention where the user experience and/or interaction with the system could be enhanced by the location.

For some embodiments, Interactive App 111 may be used to interact with visual, audio and/or sensory contents. As per this example, these interactions are made for the purpose of obtaining and/or acting upon the outcomes that were assigned to a content by users of Reference Tool or Module 102 (see Designation Module 107). Furthermore, such interactions may provide users of Interactive App 111 with the capacity to save items associated to either Content Outside Device 112 and/or Content Played by Device 113 (as defined further below), access and/or gather information, get additional content, exercise further actions such as purchases and/or experience any other possible outcome designated by users of Reference Tool or Module 102.

Additionally, in some embodiments, Interactive App 111 may include or provide access to one or more user interfaces that may allow users to create, authenticate, log into, log out of, edit and/or maintain an account. Accordingly, Interactive App 111 may also provide users with the capacity to store and/or organize saved items, information and/or content into the accounts and/or retrieve, create, manipulate, delete, edit, update, manage and/or maintain them (as described further below under Single Access Place Module 115). One example of this may be for this information to be sorted or organized in an item list or the like. In addition to this, in some embodiments of the invention, Interactive App 111 may provide e-commerce services and/or function as a marketplace so that users of Interactive App 111 may, among other things, purchase, rent, lease, license and/or reserve the saved items (products and services), information and/or content that were listed by users of Reference Tool or Module 102 by means of Designation Module 107. An example of this may be if a user of Interactive App 111 captures and saves multiple products advertised in movies, billboards & tv commercials into an item list in his/her account within the app's marketplace. When convenient, the user of Interactive App 111 may easily return to the saved products by accessing the item list, and purchase them directly; thus, using Interactive App 111 as a one-stop shop.

In some embodiments of the invention, Interactive App 111 may take the form of a native application, web application, software or any type of computerized program, system, portal, platform or Tool or Module, that can utilize the readings and/or data read, detected, captured, received, identified, interpreted and/or responded to by Device 110 from either Content Outside Device 112 and/or Content Played by Device 113. Also, as per this example, Interactive App 111 may have the capability to create, provoke, send and/or command requests, as well as read, receive, detect, interpret and/or capture responses in order to communicate with Server 103. Additionally, as per this example, depending on the requests and responses produced, Interactive App 111 and Server 103 may communicate by engaging Interaction Engine Module 114 (as described further below under Interaction Engine Module 114) and/or the Single Access Place Module 115 (as described further below under Single Access Place Module 115). For the purpose of clarity, these requests and responses are presented in FIG. 1 as Request A, Response A, Request B and Response B and will be explained further below as well.

In another aspect of System 100, Content Outside Device 112 may be any type of content displayed, played, presented, shown, streamed, projected, emitted, existing and/or executed outside Device 110. Accordingly, Content Outside Device 112 may include image data, video data, audio data, textual data, metadata, numerical data, symbols, computer or program code or language, or an audio/visual/sensory representation of the like and any such information or combination of. Also, Content Outside Device 112 may take the form of images, illustrations, videos, audio, music, photos, movies, music videos, commercials, web series, TV shows, documentaries, banners, clothing, objects, structures, art, audio books, computer and video games, software, advertisements, signage, virtual reality content, augmented reality content, mixed Reality content, live performances, sporting events, theatrical plays, or the like. In addition to this, in some embodiments, Content Outside Device 112 may be independent of Content 101. In other words, the Content 101 used by users of Reference Tool or Module 102 to establish Reference Content 109 does not have to be the same file played as Content Outside Device 112; thus it may constitute a different file and/or medium as long as it provides the same content. An example of this may be if a movie producer decides to make his/her movie interactive after it's already in theaters. For this, he/she may use a separate movie file from the ones that are being used to screen in theaters, yet once Reference Content 109 is created and outcomes & detailed information are designated, all theater screenings will automatically serve as Content Outside Device 112 (without the need to make any changes to them) due to the fact that all show the same content. As a result, movie spectators may immediately use Interactive App 111 and obtain the designated outcomes.

In yet another aspect of the invention, Content Played by Device 113 may be any type of content displayed, played, presented, shown, streamed, projected, emitted, existing, conveyed and/or executed within and/or by Device 110 and/or Interactive App 111. Accordingly, and as per this example, Content Played by Device 113 may include image data, video data, audio data, textual data, metadata, numerical data, symbols, computer or program code or language, or an audio/visual/sensory representation of the like and any such information or combination of. Also, as per this example Content Played by Device 113 may take the form of images, illustrations, videos, audio, music, photos, movies, music videos, commercials, web series, TV shows, documentaries, audio books, computer and video games, software, virtual reality content, augmented reality content, mixed reality content, or the like. Additionally, as per this example, Content Played by Device 113 may take the form of an interactive content and/or Exported Content/Selections 116 (as explained further below under Exported Content/Selections 116). Furthermore, in some embodiments of the invention, similarly to Content Outside Device 112, Content Played by Device 113 may be independent from Content 101.

Referring again to FIG. 1, in another aspect of System 100, Request A may represent any single or multiple types of requests, solicitations or petitions made by Interactive App 111 to Interaction Engine Module 114 (either directly or indirectly), for the purpose of recognizing, identifying, detecting and matching all or part of Content Outside Device 112 and/or Content Played by Device 113 with Reference Content 109 in order to trigger, activate or provide a Response A.

In some embodiments of invention, this recognition, identification, detection and/or matching may occur by means of a processing engine or unit, or any other component, program, application or software capable of receiving image, audio and/or sensory data from Interactive App 111 and recognizing, identifying, detecting and/or matching this data with Reference Content 109. For the purpose of clarity, this processing engine, unit, component, program, application or software has been labeled in FIG. 1 as Interaction Engine Module 114.

Accordingly, in some embodiments of invention, when Device 110 detects an image from Content Outside Device 112 and transmits it to Interactive App 111, Interactive App 111 may automatically (continually or systematically) or manually (by requiring an action by the user such as a click, tap, swipe, gesture, voice command, etc.) send Request A to Interaction Engine Module 114 for it to search in Server Database 108 using image recognition or computer vision to identify, detect or match the detected image from Content Outside Device 112 with Reference Content 109 for the purpose of triggering, activating or providing Response A. Similarly, another alternative may be if Interactive App 111 automatically (continually or systematically) or manually (by requiring an action such as a click, swipe, gesture or voice command) sends Request A to Interaction Engine Module 114 for it to use audio recognition, audio identification, audio signals or commands that are detectable or undetectable by the human ear, or any audio related process or processes to identify, detect or match the detected audio from Content Outside Device 112 with Reference Content 109 for the purpose of triggering, activating or providing Response A. Yet another example may be if it uses any other type of sensory recognition, identification, signals or commands such as haptic technology or experiences to identify, detect or match all or parts of Content Outside Device 112 and/or Content Played by Device 113 with Reference Content 109.

Referring again to FIG. 1, Response A may represent any single or multiple types of responses, actions or commands that Interaction Engine Module 114 may directly or indirectly send to Interactive App 111 as a response to Request A in order to produce a designated outcome (as described under Designation Module 107). For example, in some embodiments, Response A may be a limited response like a command for displaying or conveying an image, playing a video, providing information to users of Interactive App 111. As per this example, when Interaction Engine Module 114 achieves an identification, match or detection with respect to Request A, it may send Response A to Interactive App 111 in order to show the image, play the video, or show the information within Interactive App 111. However, in other embodiments, Response A may be a “call to action” for users of Interactive App 111 to interact with. For example, when Interaction Engine Module 114 achieves an identification, match or detection with respect to Request A, it may send Response A to Interactive App 111 in order to produce an interactive augmented reality experience and/or any other interactive experience (such as a clickable button or clickable image) encouraging users to take an action. As per this example, users of Interactive App 111 may act upon or interact with this “call to action” and produce a Request B (As defined below under Request B). In accordance with the above, another example may be when Interaction Engine Module 114 determines that an identification, match or detection is achieved with respect to Request A, it may send Response A to Interactive App 111, which produces an outcome such as a sound, vibration or any type of indication so that the users of Interactive App 111 understand that they can take an action such as clicking the display, pressing a button, gesturing, or emitting sound and/or any audio/visual/sensory representation to produce Request B.

In another aspect of invention, Request B may represent any single or multiple types of requests, solicitations or petitions made by users of interactive App 111 (either directly or indirectly) to Single Access Place Module 115.

In certain embodiments of the invention, these requests can be made as a consequence of Response A and/or may also result from an interaction with Exported Content/Selections 116 as explained further below. Accordingly, one example of Request B may be if users of Interactive App 111 act upon a call to action manifested as an augmented reality experience and/or any other interactive experience (such as a clickable button or clickable image) launched as a consequence of Response A, which initiates a request to Single Access Place Module 115 for a desired outcome such as storing and/or displaying item information in an item list. Similarly, another example may be if users of Interactive App 111 act upon a call to action produced as a consequence of Response A, (such as a sound, vibration or any type of indication or alert), which initiates a request to Single Access Place Module 115 for a desired outcome such as storing and/or displaying item information in an item list. Furthermore, another example may be if users of Interactive App 111 act upon a call to action such as a hotspot, tag, clickable button or image, sound or any other type of alert that may be superimposed on, induced by and/or included with Exported Content/Selections 116 (as described below under Exported Content/Selections 116), which initiates a request to Single Access Place Module 115 for a desired outcome such as storing and/or displaying item information in an item list.

Referring to FIG. 1, Single Access Place Module 115 is used to represent the component of System 100 that serves as a database management system for accessing, storing, changing, searching, editing, managing, modifying, defining, activating, deactivating, manipulating, creating, inputting, deleting, controlling and/or retrieving all data within Server Database 108 for all purposes related to Reference Tool or Module 102 and Interactive App 111, except for those assigned to Interaction Engine Module 114. Accordingly, Reference Tool or Module 102 and Interactive App 111 may provide their users with the ability to access, store, change, search, edit, manage, modify, define, activate, deactivate, manipulate, create, input, delete, control and retrieve certain information, data and/or files related to their accounts within Server Database 108 by engaging with, utilizing and/or communicating with Single Access Place Module 115. As per this example, and in some embodiments of the invention, users of Reference Tool or Module 102 may be able to apply all or some of these actions to the Content 101, selections, detailed information, outcomes and/or Reference Content 109 that have been stored in their accounts in Server Database 108; thus they may have the ability to update and make changes (at any time) to the experiences they're supplying to users of Interactive App 111 when these users interact with Content Outside Device 112 and/or Content Played by Device 113. Similarly, they may also be able to apply all or some of these actions to other account information stored in Server Database 108; like their profile information, campaign details and any other pertinent data.

Comparably, in some embodiments, users of Interactive App 111 may also be able to apply all or some of these actions to the information stored under their accounts in Server Database 108; thus they may be able to manage their item list, edit profile information, access saved items and details, retrieve their transaction history, change their purchasing details, recommend products, pull up purchase links, as well as any other action pertinent to their accounts. In accordance with the previous examples, and in some embodiments, the use of Single Access Place Module 115 may provide users of Reference Tool or Module 102 & users of Interactive App 111 with the ability to access their accounts (as well as apply any of the actions stated above) from different varieties of Reference Tool or Module 102 (e.g. SAAS platforms, native apps), Device 110 (e.g. cell phones & laptops) and/or Interactive App 111 (e.g. native apps & web apps) and sustain a congruent experience every time they access, as long as the Reference Tool or Module 102, Device 110 and/or Interactive App 111 used can engage with, utilize, communicate with and obtain permission from the Single Access Place Module 115. Hence users of Reference Tool or Module 102 & users of Interactive App 111, in some embodiments of the invention, may access the information stored in their accounts via multiple means which allows for a more homogeneous and less limited experience.

Additionally, in some embodiments of the invention, Single Access Place Module 115 may serve and/or provide e-commerce services for the purpose of processing payments and/or other transactions related to the buying and selling of goods and services by means of Interactive App 111. These services may include any type of e-commerce and digital marketplace models such as Business to Consumer (B2C), Business to Business (B2B), Consumer to Consumer (C2C) and Consumer to Business (C2B) and may involve retail, wholesale, drop shipping, crowdfunding, subscriptions, physical products and/or digital products and services. E-commerce services can be provided directly at the Single Access Place Module 115, indirectly via a Market Place module 119 or a combination of both types of services as illustrated in FIG. 1.

Furthermore, as per this example, Single Access Place Module 115 may take the form of a processing engine or unit, or any other component, program, application or software capable of accomplishing the functions and services attributed herein to Single Access Place Module 115.

Referring once again to FIG. 1, Response B may represent any single or multiple types of responses, actions or commands that the Single Access Place Module 115 may directly or indirectly send to Interactive App 111 as a response to Request B in order to produce a designated outcome (as described under Designation Module 107). For example, when Single Access Place Module 115 receives Request B, it may store an item in an item list, produce a purchase, share information, make a reservation, provide additional content and/or any other action requested (including providing the option for further actions); as well as provide an alert to user of Interactive App 111 that the requested action has been completed. Accordingly, in some embodiments, certain Response B may lead to further Response B. One example of this may be a Response B that provides an option menu to a user of Interactive App 111 which he/she interacts with to produce another Request B to Single Access Place Module 115, which in turn provides another Response B; and so on.

Referring again to FIG. 1, in some embodiments, Interaction Engine Module 114, Request A and Response A may be unneeded or bypassed; thus avoiding the use of the recognition, identification, detection and/or matching processes (as described under Interaction Engine Module 114). In these embodiments, alternative options may be implemented to allow users of Interactive App 111 to interact with Content Played by Device 113 and produce Request B without a Request A or a Response A. Accordingly, in these embodiments interactions are achieved by engaging with the Single Access Place Module 115 solely and thus Interaction Engine Module 114 is not used. Since the Single Access Place Module 115 is still used, all the processes that take place after Request B occur as discussed previously for System 100; including the capacity for users of Reference Tool or Module 102 to update outcomes and detailed information when they see fit, as well as the storing of data for each interaction. Therefore, what changes are just the processes discussed for Interaction Engine Module 114.

For example, in some embodiments of the invention, users of Reference Tool or Module 102 may have the option to export content that they've made interactive (e.g. Content 101 with selections, designated outcomes and detailed information) so that users of Interactive App 111 can interact with it without the need of the recognition, identification, detection and/or matching processes. In other embodiments, the option to export just the selections with the designated outcomes and detailed information (which can be synchronized with Content Played by Device 113) may be available in order achieve the same purposes.

For some of these embodiments, exporting may be achieved in different ways. One example may be if the interactive content (e.g. Content 101 with selections, designated outcomes and detailed information) is presented as Content Played by Device 113 through streaming, so that users of Interactive App 111 may interact with it to produce Request B without Request A or Response A. Another example may be if just the selections (with the designated outcomes and detailed information) are streamed and thus synchronized with Content Played by Device 113. In yet other embodiments, users of Reference Tool or Module 102 may export a downloadable file of the interactive content (e.g. Content 101 with selections, designated outcomes and detailed information) with embedded tags, links, hotspots or call to actions that users of Interactive App 111 may interact with when playing it as Content Played by Device 113. Accordingly, in other embodiments of the invention, a similar approach may be taken but with a downloadable file that just contains the tags, links, hotspots, buttons or call to actions that can be synchronized with content that is being played as Content Played by Device 113.

For illustrative purposes these exports (exported selections, designated outcomes and detailed information including or excluding Content 101) have been presented in FIG. 1 as Exported Content/Selections 116.

In further aspects of the invention, details and data of interactions by users of Interactive App 111, such as Response A & Request B, as well as any other data developed by means of Single Access Place Module 115 and Interaction Engine Module 114 may be collected by Server 103 into Server Database 108 and/or any other repositories. Additionally, as per this example and depending on the embodiment of the invention that is in place, this data may be analyzed by either Server 103, Reference Tool or Module 102 and/or other Tool or Modules. Furthermore, in certain embodiments of the invention, users of Reference Tool or Module 102 may be able to access this data and/or analyses by means of an analytics component of Reference Tool or Module 102; represented in FIG. 1 for illustrative purposes as Analytics Module 117. Yet in other embodiments, users of Reference Tool or Module 102 may receive those data and/or analyses by other means such as email, text, traditional mail, data transfers, etc.

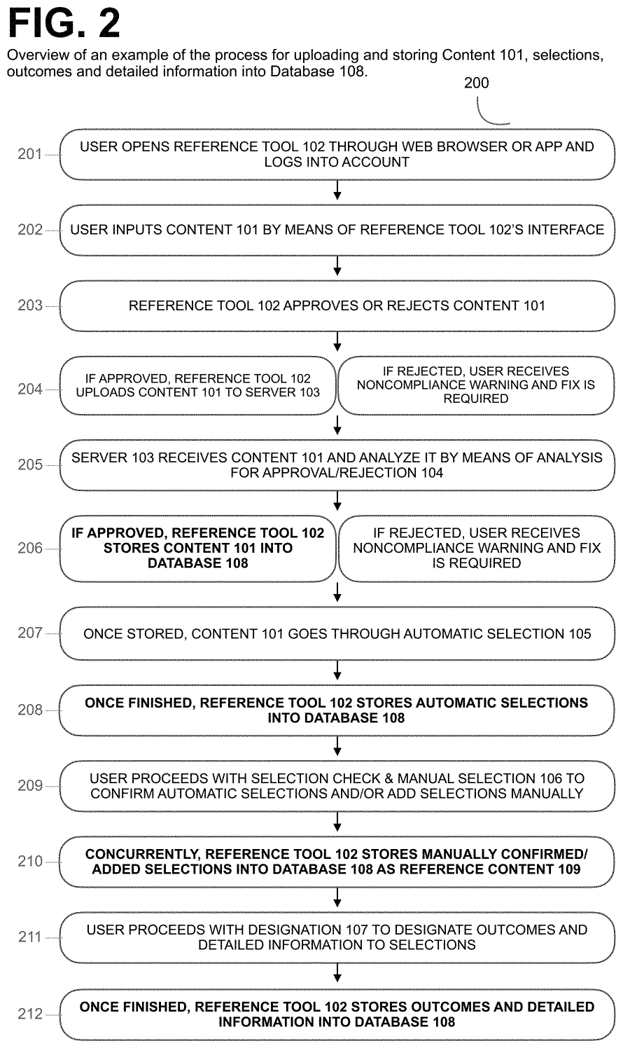

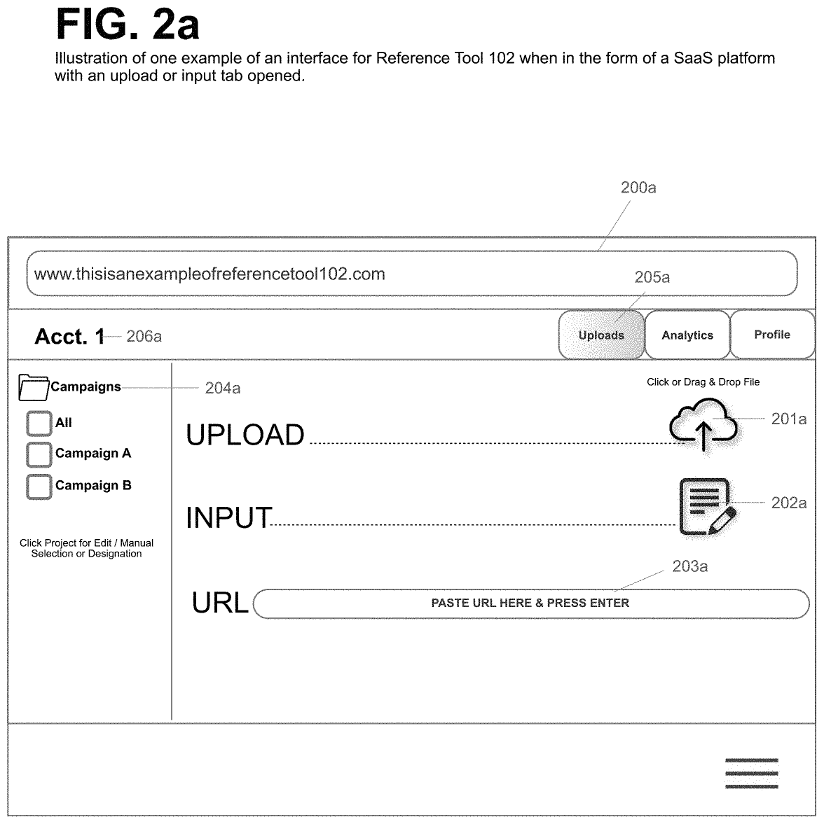

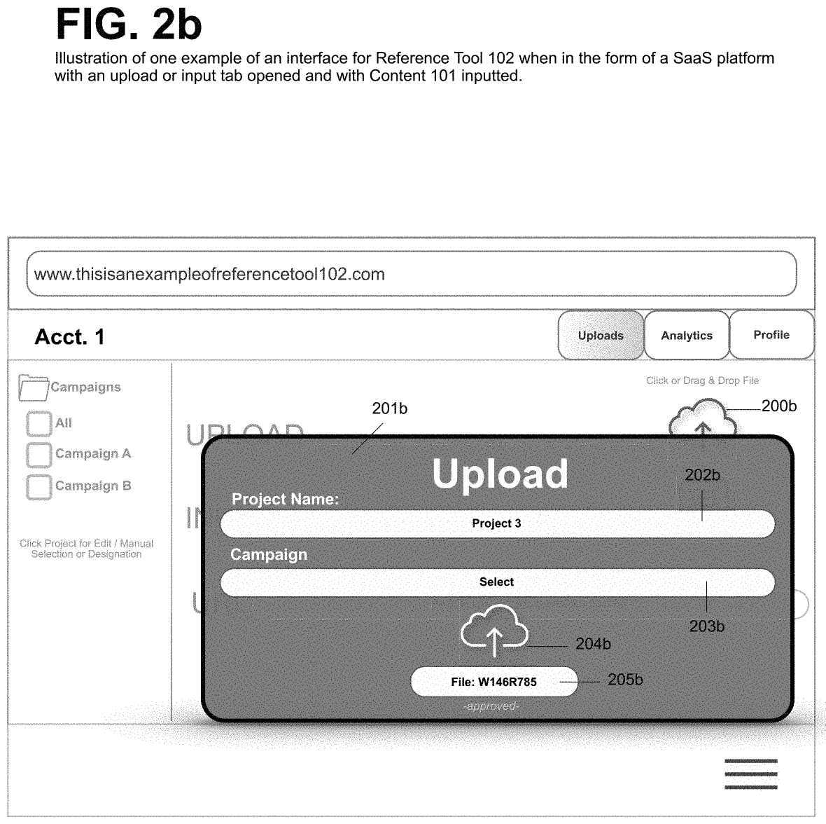

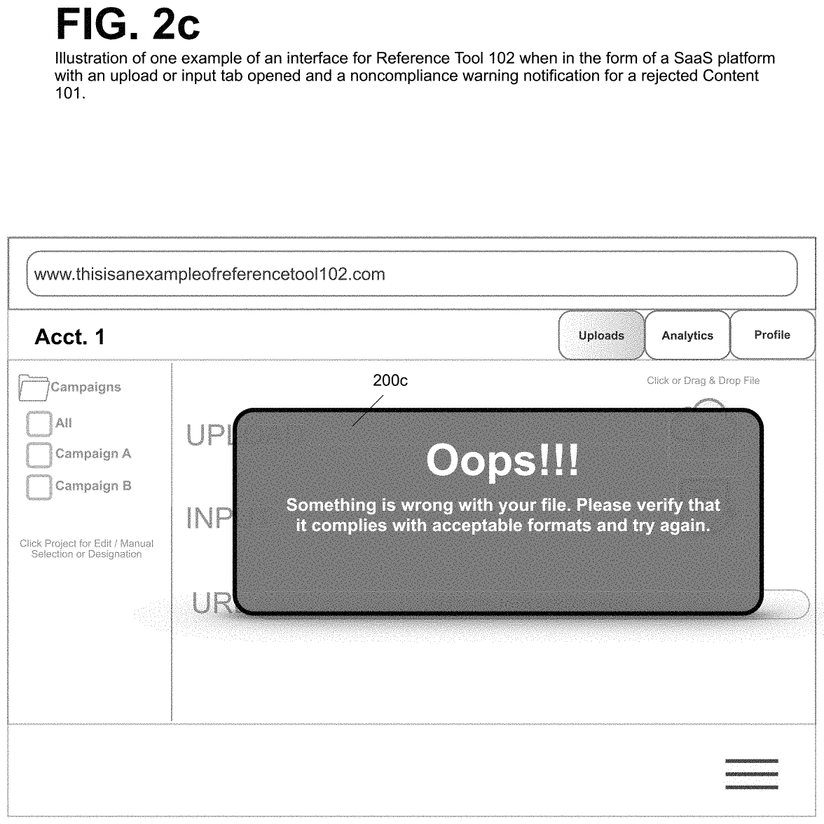

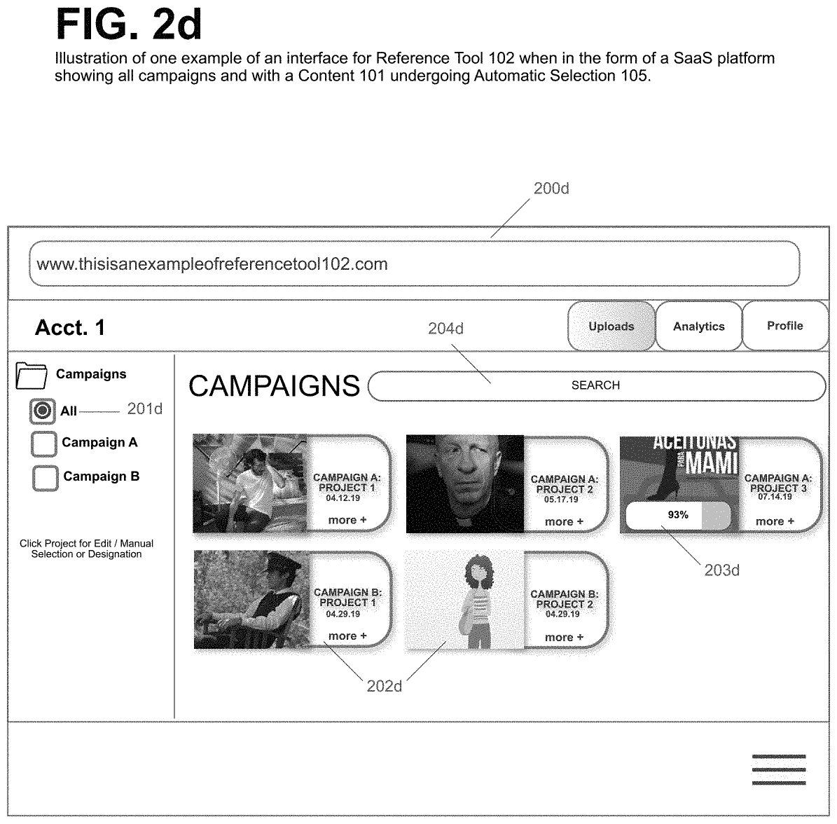

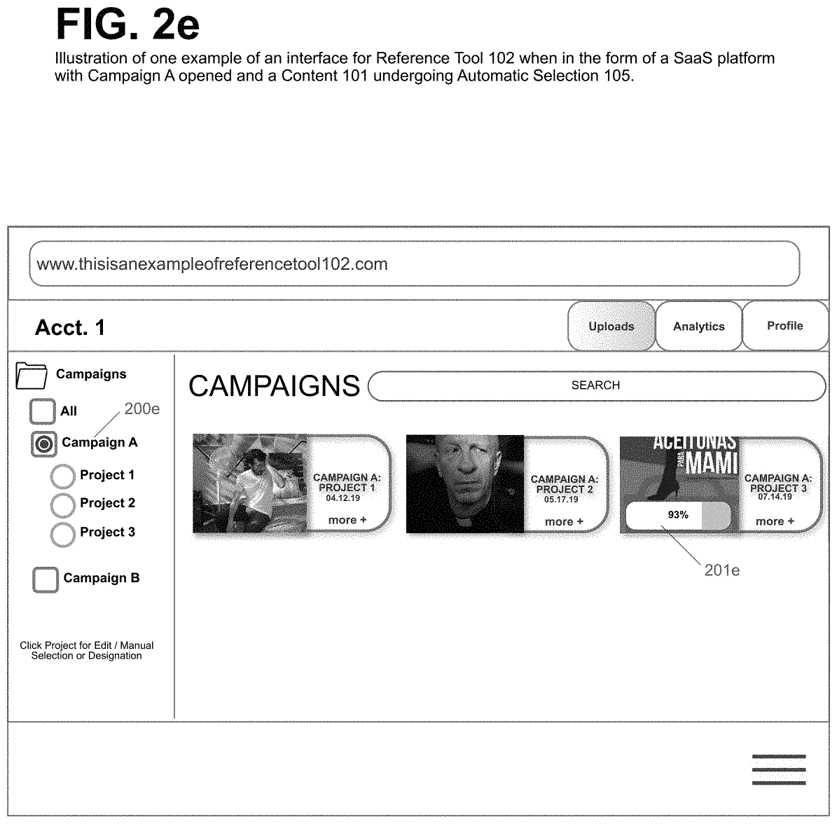

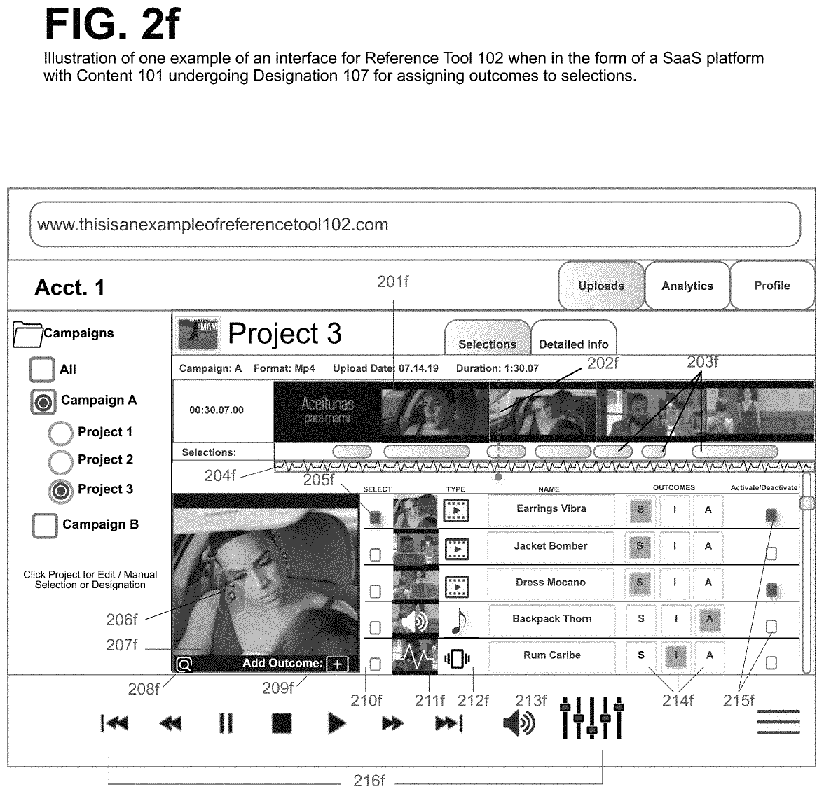

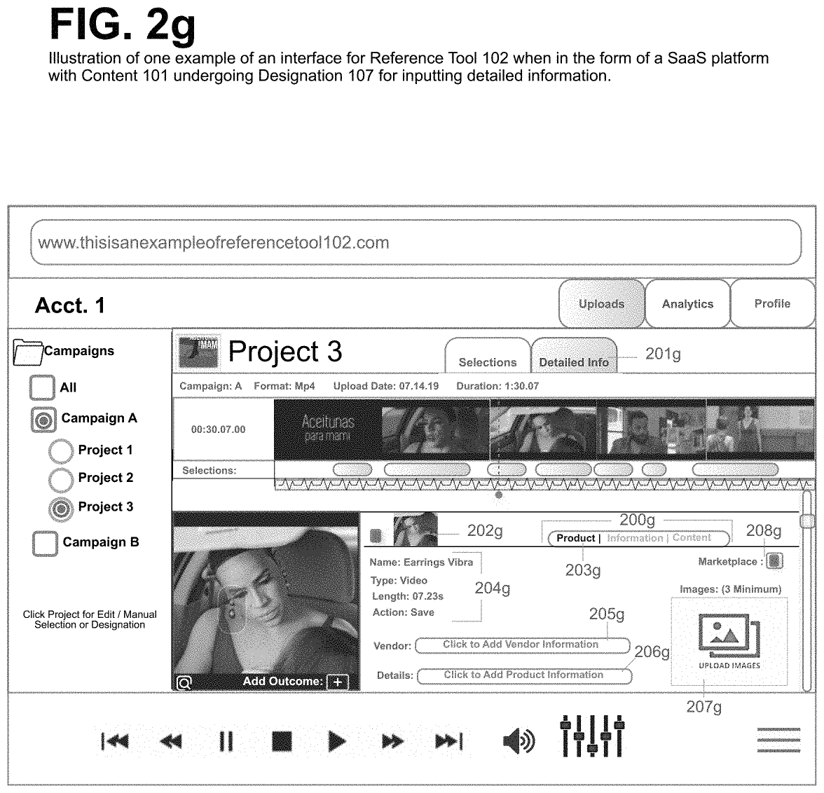

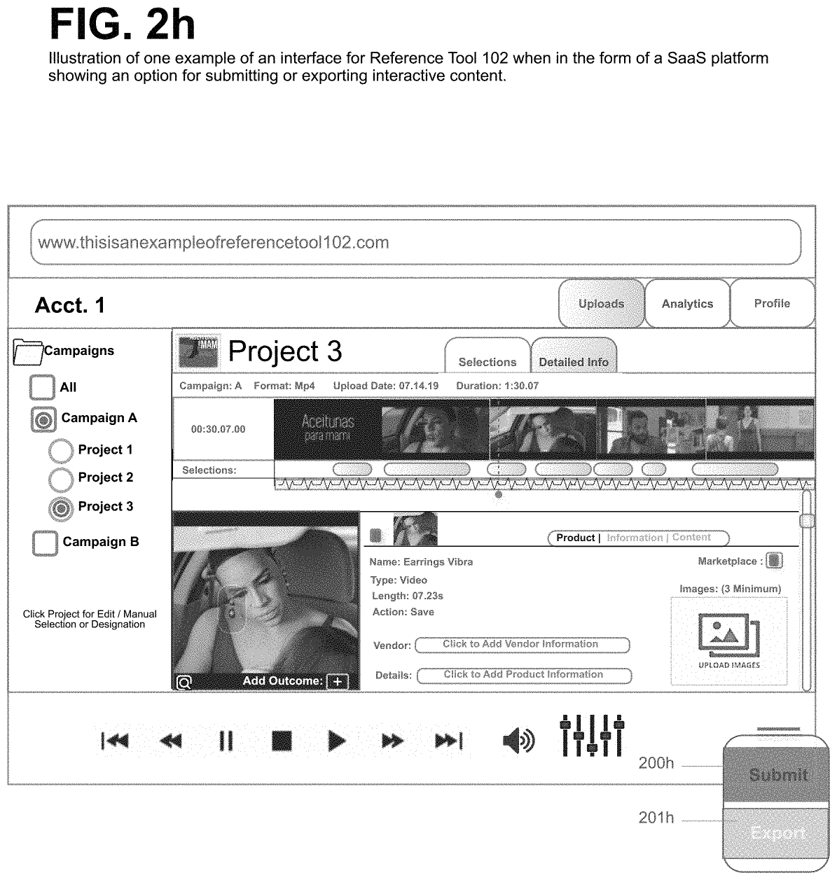

FIG. 2 represents, in the form of a flowchart, an overview of one example of the process for uploading and storing Content 101, selections, outcomes and detailed information into Server Database 108, in one embodiment according to the present invention. It must be noted that FIG. 2 represents an example and in no way limits any other possibility that may be induced or derived from this disclosure. For clarity we've depicted the process as Process 200 in this example. Process 200 begins with step 201 when the user opens Reference Tool or Module 102 through a web browser or an app and logs into his/her account. For the purpose of this example, the user has already created an account with Reference Tool or Module 102 prior to this engagement. Then follows step 202 where the user inputs Content 101 by means of the Reference Tool or Module 102's interface. Following is step 203 which shows that Reference Tool or Module 102 approves or rejects the Content 101 that was inputted; a process that may be based on quality, format, size of file, resolution, file type or any other criteria required of Content 101 to be supported by System 100. Next is step 204, which illustrates that if Content 101 is approved, Reference Tool or Module 102 will upload it to Server 103, but if rejected, the user may receive a noncompliance warning and be required to make changes or fix the problem. Then step 205 demonstrates that once Content 101 is approved, Server 103 receives the content and analyzes it by means of Analysis for Approval/Rejection Module 104. Following is step 206 which addresses two possibilities. The first is that if Content 101 is approved by Analysis for Approval/Rejection Module 104, Reference Tool or Module 102 will store Content 101 into Server Database 108. Conversely, the second possibility is that Content 101 may be rejected in which case the user may receive a noncompliance warning and a fix might be required (similar to what was presented under Analysis for Approval/Rejection Module 104 for FIG. 1). Afterwards comes step 207 which indicates that once Content 101 is approved by Analysis for Approval/Rejection Module 104 and stored in Server Database 108 it may go through Automatic Selection Module 105. Once the process for Automatic Selection Module 105 has finished, step 208 occurs, which entails Reference Tool or Module 102 storing automatic selections in Server Database 108. Next in step 209 the user proceeds with Selection Check & Manual Selection Module 106 to confirm automatic selections and/or add other selections manually. Then as confirmation of selections and manual selections occur, Reference Tool or Module 102 stores manually confirmed/added selections into Server Database 108 as Reference Content 109 as stated in step 210. Following, in step 211, the user proceeds with Designation Module 107 and designates outcomes and detailed information to selections. Once finished, step 212 is realized with Reference Tool or Module 102 storing the outcomes and detailed information in Server Database 108.

FIG. 2a represents an illustration of one example of an embodiment of the present invention, which features an Interface for Reference Tool or Module 102, when in the form of a SaaS platform, with an upload or input tab opened. It must be noted that FIG. 2a represents an example and in no way limits any other possibility that may be induced or derived from this disclosure. For this example, Reference Tool or Module 102 (labeled for clarity as 200a in this example) has been opened within a browser and the ‘Uploads’ tab 205a has been selected making available 3 options for content upload or input. First an upload option (201a) is shown, which may function by clicking the upload icon, depicted as a cloud with an arrow, or by dragging and dropping the content in the form of a file over the icon. Second, an input option (202a) is made available and access to it may be gained by clicking the icon depicted as a page with a pencil. The third option may function by writing or copy & pasting a URL (203a) of the content you wish to upload in the space provided and pressing enter. Within this example, a section for campaigns in the form of a folder and file structure has also been illustrated on the left side of the window. For illustrative purposes, this example shows an open ‘Campaigns’ folder (204a) and under it, as if pertaining to it, are checkboxes for “All” campaigns, “Campaign A” and “Campaign B”. This example also illustrates the possibility of having this upload option as the default window when the ‘Uploads’ tab (205a) is active but none of the checkboxes for the campaigns have been selected. Additionally, FIG. 2a also serves to show that all these actions are available when an account has been created and for that reason Acct. 1 (206a) is depicted.

FIG. 2b is an illustration of one example of an interface for Reference Tool or Module 102, when in the form of a SaaS platform, with an upload or input tab opened and with Content 101 inputted. It must be noted that FIG. 2b represents an example and in no way limits any other possibility that may be induced or derived from this disclosure. This example demonstrates the possibility of having an upload window (201b) appear when the upload option (201a) from FIG. 2a (in this example labeled as 200b) is clicked or when content is dragged and dropped over it. In this example a space for providing the project name (202b) is provided, and also a checkbox to choose the campaign (203b) for which this project belongs to. It also depicts a space that illustrates the file name (205b) which serves to show that the file inputted was approved by Reference Tool or Module 102's approval/rejection. Furthermore, it also shows an upload icon (204b) that may be pressed to submit information and content to Analysis for Approval/Rejection Module 104.

FIG. 2c is an illustration of one example of an interface for Reference Tool or Module 102, when in the form of a SaaS platform, with an upload or input tab opened and showing a noncompliance warning notification for a Content 101 that has been rejected by Analysis for Approval/Rejection Module 104. It must be noted that FIG. 2c represents an example and in no way limits any other possibility that may be induced or derived from this disclosure. As per step 205 in FIG. 2, when Content 101 is uploaded, Server 103 analyzes it by means of Approval/Rejection Module 104. Then as per step 206 of FIG. 2, it approves or rejects the Content 101. Accordingly, if rejected, the user receives a noncompliance warning and a fix is required. FIG. 2c illustrates one example of this noncompliance warning (200c) in one embodiment of this invention.

FIG. 2d is an illustration of one example of an interface for Reference Tool or Module 102, when in the form of a SaaS platform, showing all campaigns and with an uploaded Content 101 undergoing Automatic Selection Module 105. It must be noted that FIG. 2d represents an example and in no way limits any other possibility that may be induced or derived from this disclosure. FIG. 2d exhibits a possibility of what may occur when the “All” campaigns checkbox (201d) is selected. In this example it shows tiles (202d) for each Content 101 project in all campaigns. Furthermore, this example depicts Project 3 of Campaign A still undergoing the automatic selection process (203d); which is illustrated by the progress bar of 93%. With this, FIG. 2d strives to illustrate the possibility of a user to keep utilizing the Reference Tool or Module 102's features (200d) on other projects while one project is undergoing the automatic selection process. Also, within this example, each tile is depicted with essential information, particularly project name, the identity of the campaign it belongs to and upload date; as well as a “more+” option to allow for further information or actions related to the project. Additionally, a search option (204d) is illustrated to exhibit the possibility of searching for a specific project or campaign.

FIG. 2e is an illustration of one example of an interface for Reference Tool or Module 102, when in the form of a SaaS platform, with Campaign A opened and a Content 101 undergoing Automatic Selection Module 105. It must be noted that FIG. 2e represents an example and in no way limits any other possibility that may be induced or derived from this disclosure. In FIG. 2e, checkbox for Campaign A (200e) is depicted as checked and three projects are revealed. Additionally, three tiles are shown in the right pane, (particularly those belonging to Campaign A), instead of the five tiles shown in FIG. 2d. Furthermore, this example depicts Project 3 of Campaign A still undergoing the Automatic Selection Module 105 process (201e).

FIG. 2f is an illustration of one example of an interface for Reference Tool or Module 102, when in the form of a SaaS platform, with Content 101 undergoing Designation Module 107 for assigning outcomes to selections. It must be noted that FIG. 2f represents an example and in no way limits any other possibility that may be induced or derived from this disclosure. FIG. 2f demonstrates an example, in one embodiment of this invention, of how a user of Reference Tool or Module 102 may assign outcomes to selections of Content 101 by means of Designation Module 107. In this illustration, Content 101 (a movie as per this example) and its selections are portrayed within a timeline (201f). The elongated circles beneath the video timeline (203f) represent the selections previously made by Automatic Selection Module 105 and/or Selection Check & Manual Selection Module 106 to Content 101. The enlarged thumbnail image (207f) represents the selection to which the user of Reference Tool or Module 102 wants to assign an outcome. This image may appear by clicking any of the selections (203f), moving a cursor (202f) through the video timeline, playing the video with the playback controls (216f) and stopping on the desired selection, or by checking one of the checkboxes (205f/210f) next to the column with smaller image thumbnails (211f) which represent selections with outcomes. Once the user chooses the selection to which he/she wants to assign an outcome, he/she may proceed by clicking “Add Outcome” (209f). As per this example, this feature (209f) may provide the user with the option to add a bounding box surrounding the earrings (206f) as one of the desired outcomes. Additionally, the user may include the option for “Saving the item” as an outcome by selecting de “S” under the “Outcomes” menu (214f). To make this interaction available to users of Interactive App 111, the user of Reference Tool or Module 102 may activate the designated interaction by checking the checkbox (215f) next to the “Outcomes” menu and under “Activate/Deactivate” (215f). Accordingly, the user of Reference Tool or Module 102 may deactivate any of these interactions at any time, thus disabling the possibility of interaction for users of Interactive App 111. This process may be applied to the audio of Content 101 as well, which is portrayed in the illustration under the video timeline as an audio track (204f). For the purpose of clarity, Reference Tool or Module 102 may specify the type of content that the user is making interactive as shown in the illustration under “Type” (212f), next to the selections' thumbnails, which depicts icons representing video, audio or haptic contents. Additionally, Reference Tool or Module 102 may provide users with the option of inputting names or categories to the designations as shown in the illustration under “Name” (213f). FIG. 2f also presents the option for users of Reference Tool or Module 102 to preview the outcomes that they are assigning to the selections by clicking the icon 208f.

FIG. 2g serves to illustrate one example of an interface for Reference Tool or Module 102, when in the form of a SaaS platform, with Content 101 undergoing Designation Module 107 for inputting detailed information. It must be noted that FIG. 2g represents an example and in no way limits any other possibility that may be induced or derived from this disclosure. After completing the process described in FIG. 2f, the user of Reference Tool or Module 102 may proceed with, or be moved on to, the process illustrated in FIG. 2g which is shown within the same interface but under a new tab titled “Detailed Info” (201g). As per this example, the checked selection (from 203f in FIG. 2f), may represent the selection to which the user of Reference Tool or Module 102 will input detailed information for the designated outcomes. Accordingly, a menu (200g) is supplied for selecting which detailed information Tool or Module applies (Product/Information/Content); exhibiting the possibility of having different Tool or Modules that pertain to the information needed for the type of outcome desired. In this example, a Tool or Module for “Product” is activated (203g) thus providing options for inputting detailed information pertaining to a product (similar to those needed for listing a product into a digital marketplace) including the upload of images of the product (207g), input of product specifications such as the price, brand, size, etc. (206g) as well as the vendor information (205g) for authentication purposes. Furthermore, a checkbox labeled “Marketplace” (208g) is given to depict an option for users of Reference Tool or Module 102 to activate purchase options for that product and thus make it purchasable by the users of Interactive App 111.

FIG. 2h represents an illustration of one example of an interface for Reference Tool or Module 102, when in the form of a SaaS platform, showing an option for submitting or exporting interactive content. It must be noted that FIG. 2h represents an example and in no way limits any other possibility that may be induced or derived from this disclosure. In this example, FIG. 2h depicts the option to submit (200h) selections and designations (outcomes and detailed information) in order to store them into Server Database 108 and thus allow users of Interactive App 111 to interact with interactive content. FIG. 2h also exhibits the option to export (201h) for the purposes discussed in FIG. 1 under Exported Content/Selections 116; as well as for sharing, such as but not limited to, sharing through social or private networks, sharing a preview, sharing a working file, sharing selections and/or detailed information, etc.

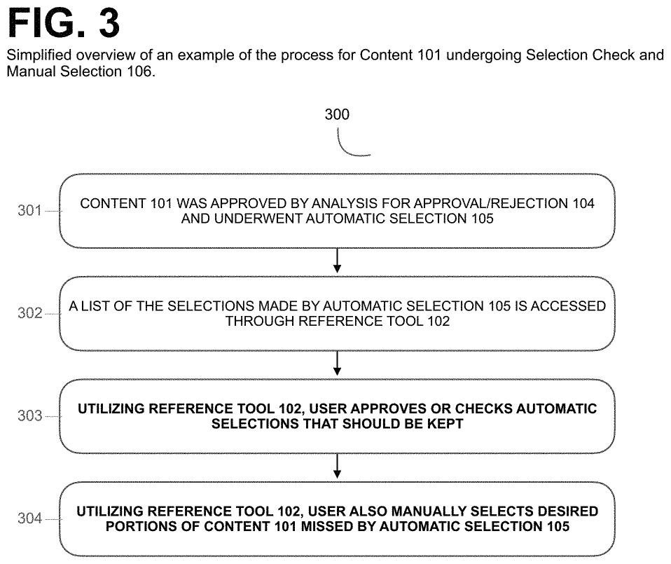

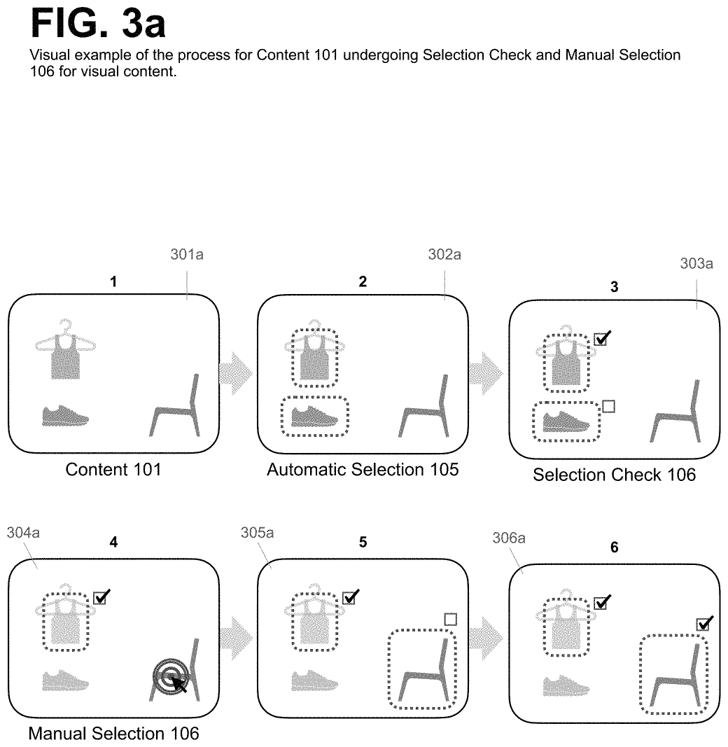

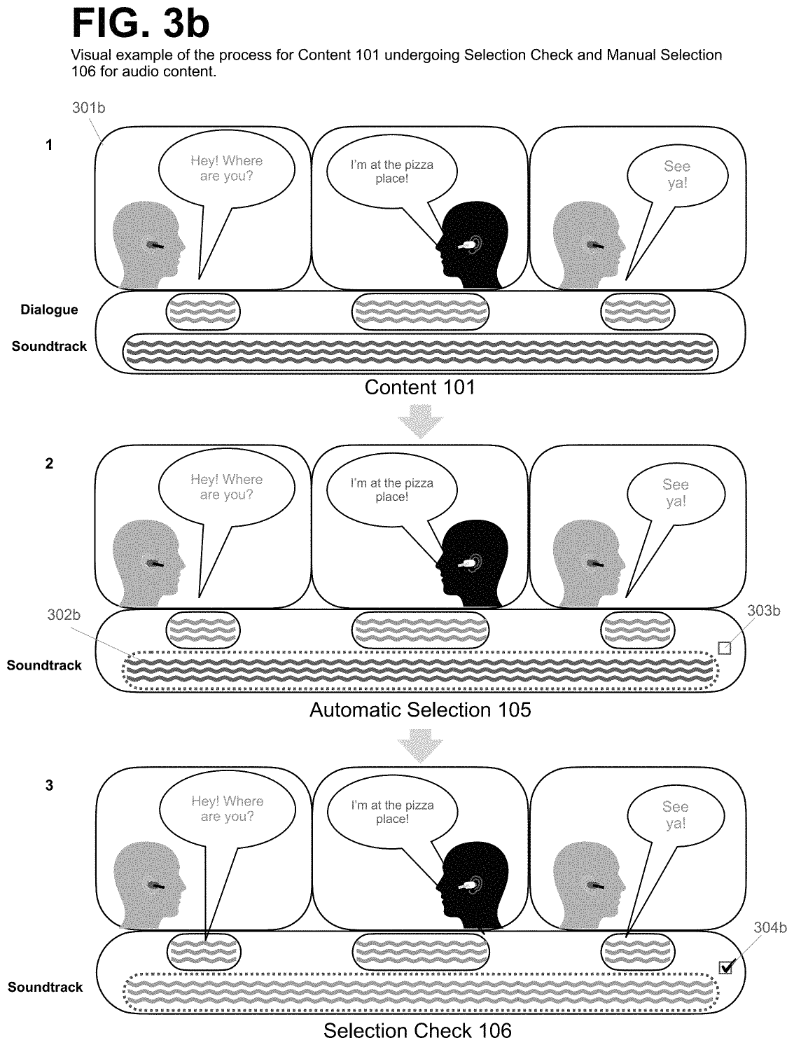

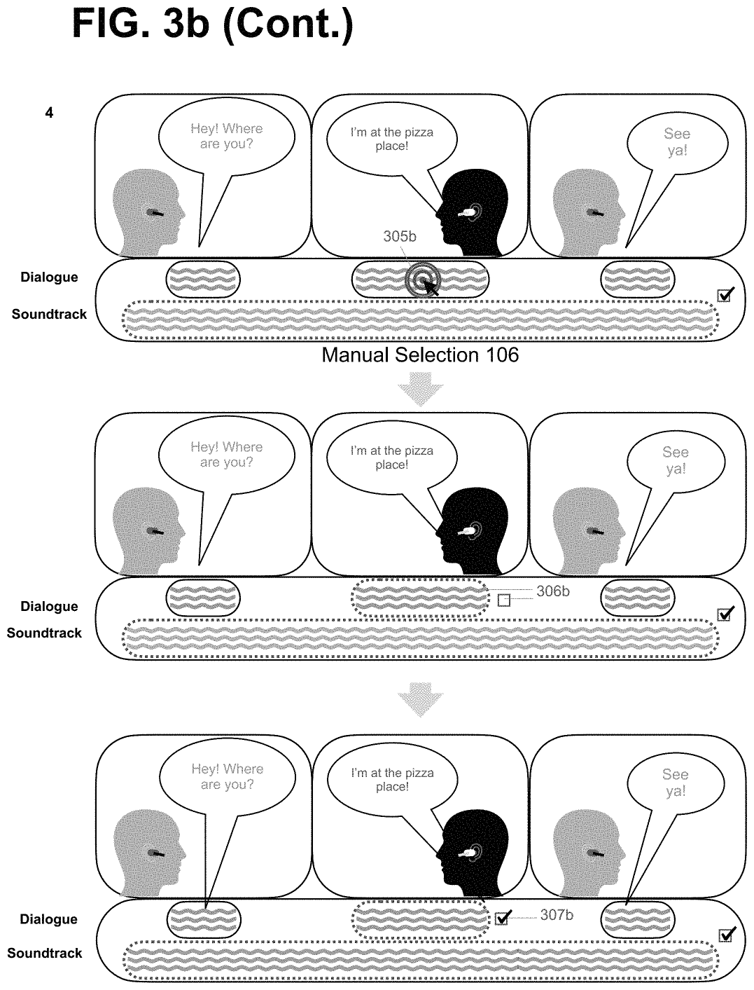

FIG. 3 represents, in the form of a flowchart, a simplified overview of an example of the process for Content 101 undergoing Selection Check and Manual Selection Module 106. It must be noted that FIG. 3 represents an example and in no way limits any other possibility that may be induced or derived from this disclosure. For clarity we've depicted the process as Process 300 in this example. Process 300 begins with step 301 in which Content 101 has already been approved by Analysis for Approval/Rejection Module 104 and has undergone Automatic Selection Module 105. Consequently, as per step 302, a list of the selections made by Automatic Selection Module 105 is accessed through Reference Tool or Module 102 by the user. Afterwards is step 303, whereby utilizing Reference Tool or Module 102, the user approves or checks automatic selections that he/she wants to keep. Furthermore, the user then may follow with step 304 which states that utilizing Reference Tool or Module 102, he/she can also manually select desired portions of Content 101 missed by Automatic Selection Module 105.

FIG. 3a represents one visual example, of one embodiment of the current invention, of the process for Content 101 undergoing Selection Check and Manual Selection Module 106 for visual content. It must be noted that FIG. 3a represents an example and in no way limits any other possibility that may be induced or derived from this disclosure. As per this example, this process begins with Content 101 having been approved (301a) by Analysis for Approval/Rejection Module 104 depicted in FIG. 1. Consequently, this example then illustrates what constitutes one possibility of a next step after approval, which is Automatic Selection Module 105 (302a), by depicting two of the items selected (indicated by the surrounding bounding boxes). Accordingly, it should be noted for this example that the selection in Automatic Selection Module 105 may consist of one or more processes or Tool or Modules that automatically select all or parts of Content 101. Following, FIG. 3a depicts Selection Check 106 (303a) by showing a checkmark in one of the checkboxes next to the items automatically selected by Automatic Selection Module 105 which alludes to the decision by the user of Reference Tool or Module 102 to keep the selection of one of the items selected. Next FIG. 3a shows one example of Manual Selection Module 106 (304a) by illustrating a cursor over the chair item, followed by the appearance of a bounding box around the chair and of a checkbox next to it (305a); which is then followed by an image that includes the checkbox having been checked (306a) as to demonstrate a selection of the chair based on the idea that it was manually selected.

FIG. 3b is a visual example, of one embodiment of the current invention, of the process for Content 101 undergoing Selection Check & Manual Selection Module 106 for audio content. It must be noted that FIG. 3b represents an example and in no way limits any other possibility that may be induced or derived from this disclosure. As per this example of one embodiment of the present invention, this process begins with Content 101 having been approved (301b) by Analysis for Approval/Rejection Module 104 depicted in FIG. 1. Consequently, this example then illustrates what constitutes one possibility of a next step after approval, which is Automatic Selection Module 105 (302b), by depicting the soundtrack track being selected (302b), which is indicated by a surrounding bounding box and a checkbox next to it (303b). Accordingly, it should be noted for this example that the selection in Automatic Selection Module 105 may consist of one or more processes or Tool or Modules that automatically select all or parts of Content 101. Following, FIG. 3b depicts Selection Check 106 by showing a checkmark (304b) in one of the checkboxes next to the soundtrack track automatically selected by Automatic Selection Module 105 which alludes to the decision by user of Reference Tool or Module 102 to keep the selection of the soundtrack. Next, FIG. 3b shows one example of Manual Selection Module 106 by illustrating a cursor over one of the regions within the dialogue track (305b), followed by the appearance of a bounding box around the mentioned region and of a checkbox next to it (306b); which is then followed by an image that includes the checkbox having been checked (307b) as to demonstrate that the dialogue was manually selected.

As discussed, in some embodiments of the proposed invention, once Content 101 has been made interactive or engageable (e.g. Reference Content 109) by means of System 100, including but not limited to any of the processes presented in this disclosure, users of Device 110 may be able to engage with this content or portions of it. For clarity, some examples of these engagements or interactions are provided in some of the following drawings. It must be noted that these drawings represent examples and in no way limit any other possibility that may be induced or derived from this disclosure.

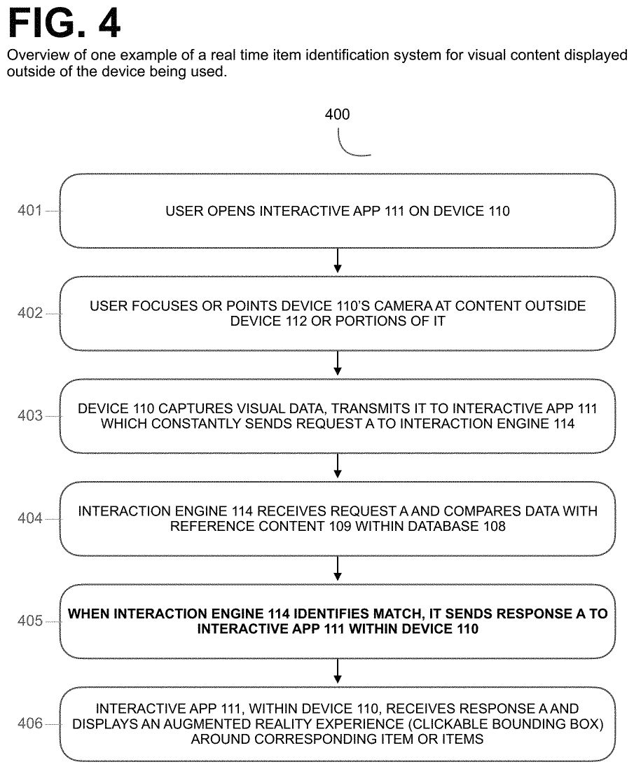

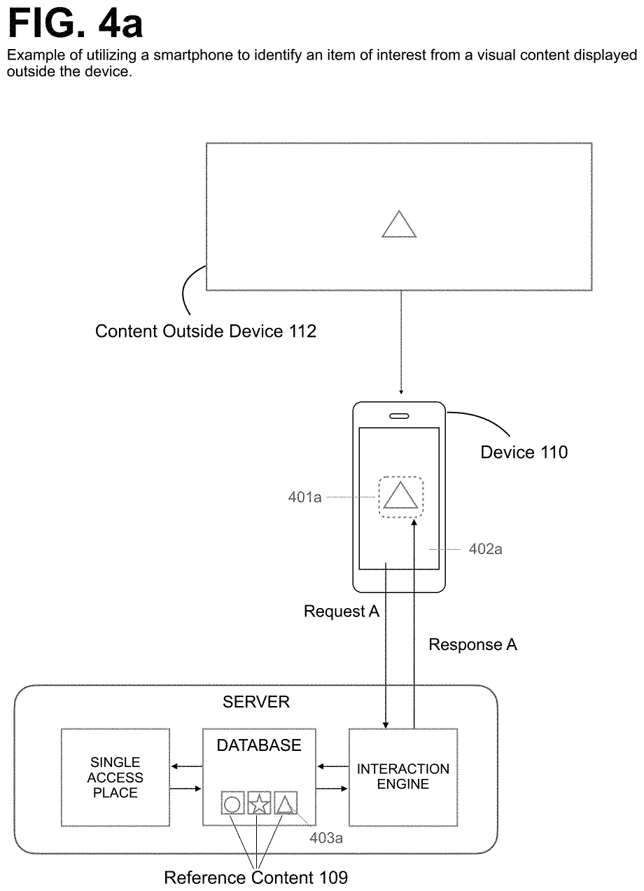

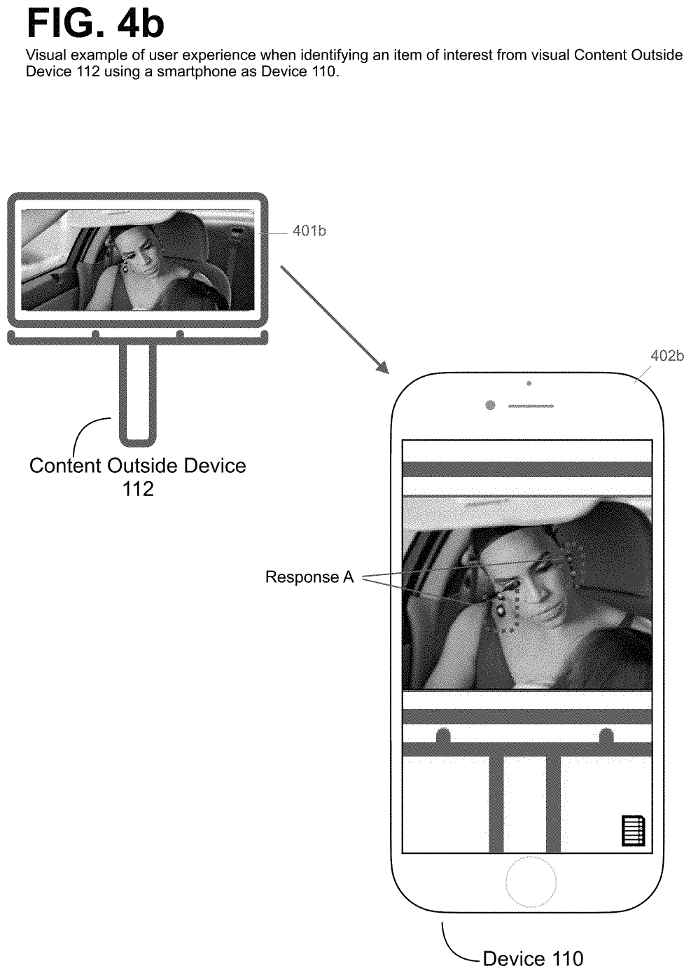

FIG. 4 represents, in the form of a flowchart, an overview of one example of a real time item identification system for visual content displayed outside of the device being used. It must be noted that FIG. 4 represents an example and in no way limits any other possibility that may be induced or derived from this disclosure. For clarity we've depicted this process as Process 400 in this example. Process 400 begins with the user opening the Interactive App 111 on Device 110 as established in step 401. For the purpose of this example, the user has already created an account prior to this engagement, but other embodiments of the present invention may not require an account to be made or may require it later in this process or after said process. Then follows step 402 where the user focuses or points Device 110's camera at Content Outside Device 112 or portions of it (such as items). Following is step 403 where Device 110 reads or captures data (e.g. image, textual or video data) and transmits it to Interactive App 111, which constantly sends Request A to Interaction Engine Module 114. Then in step 404, FIG. 4 indicates that Interaction Engine Module 114 receives Request A and compares the data with Reference Content 109 within Server Database 108. Afterwards, as per step 405, when Interaction Engine Module 114 identifies a match, it sends Response A to Interactive App 111 within Device 110. Step 406 follows, where Interactive App 111, within Device 110, receives Response A and displays an augmented reality experience such as a clickable bounding box around the corresponding item or items.

FIG. 4a illustrates an example of utilizing a smartphone to identify an item of interest from a visual content displayed outside the device. It must be noted that FIG. 4a represents an example and in no way limits any other possibility that may be induced or derived from this disclosure. From top to bottom, FIG. 4a first depicts a rectangle representing a screen or other platform displaying Content Outside Device 112. In this example a triangle within the rectangle represents an item shown within the Content Outside Device 112. Then, the example follows with an arrow pointing down which represents the visual information or data that is being received or detected by the camera of the smartphone or Device 110. Also in this example, a triangle can be seen within the smartphone or Device 110 representing the item shown within the Content Outside Device 112 that has been detected by the Interactive App 111 (402a) within the smartphone or Device 110. For this example it must also be noted that the Interactive App 111 is open, functioning and sending Request A to Interaction Engine Module 114 within Server 103 when Device 110's camera focuses on Content Outside Device 1112. Additionally, this example illustrates one possible representation of Server 103 with the Interaction Engine Module 114, Server Database 108, and Single Access Place Module 115; also depicting the item detected as having a matching Reference Content 109 (403a). Finally we can observe that a Response A is shown to indicate Interaction Engine Module 114's response to the match and its outcome is depicted as the AR bounding box (401a) surrounding the triangle within the Interactive App 111 operating in the smartphone (Device 110).

FIG. 4b shows a visual example of a user experience when identifying an item of interest from visual Content Outside Device 112 using a smartphone as Device 110. It must be noted that FIG. 4b represents an example and in no way limits any other possibility that may be induced or derived from this disclosure. As per this example, while having Interactive App 111 opened on a smartphone (Device 110), a user aims the smartphone's camera toward a billboard (401b) with Content Played Outside 112. Then the Interactive App 111 within the smartphone (402b) displays bounding boxes (Response A) surrounding items that the user of Interactive App 111 can interact with.

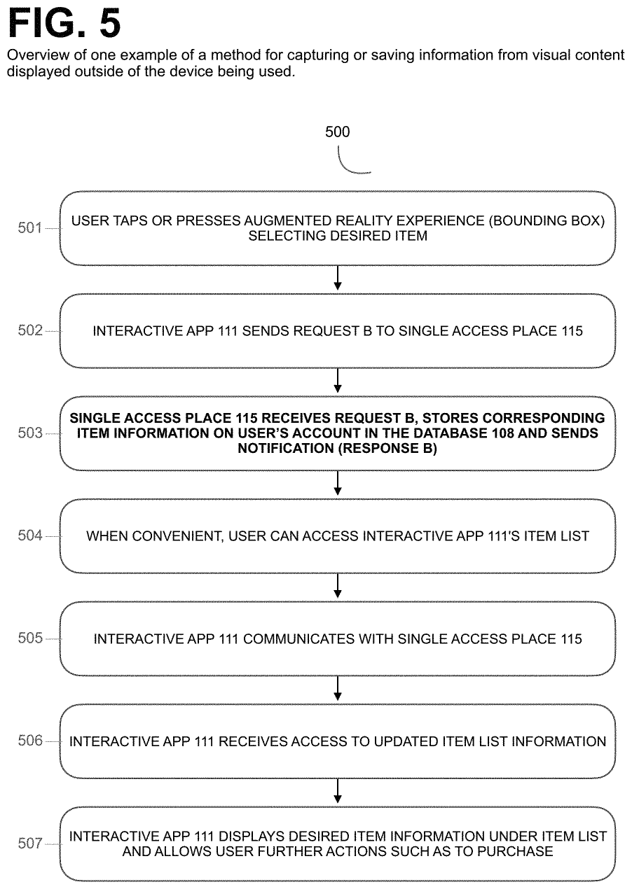

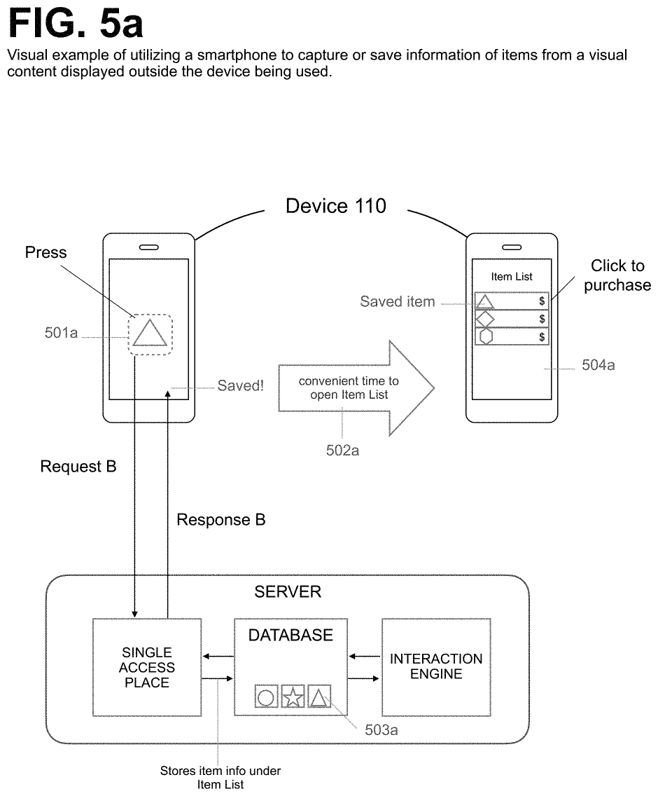

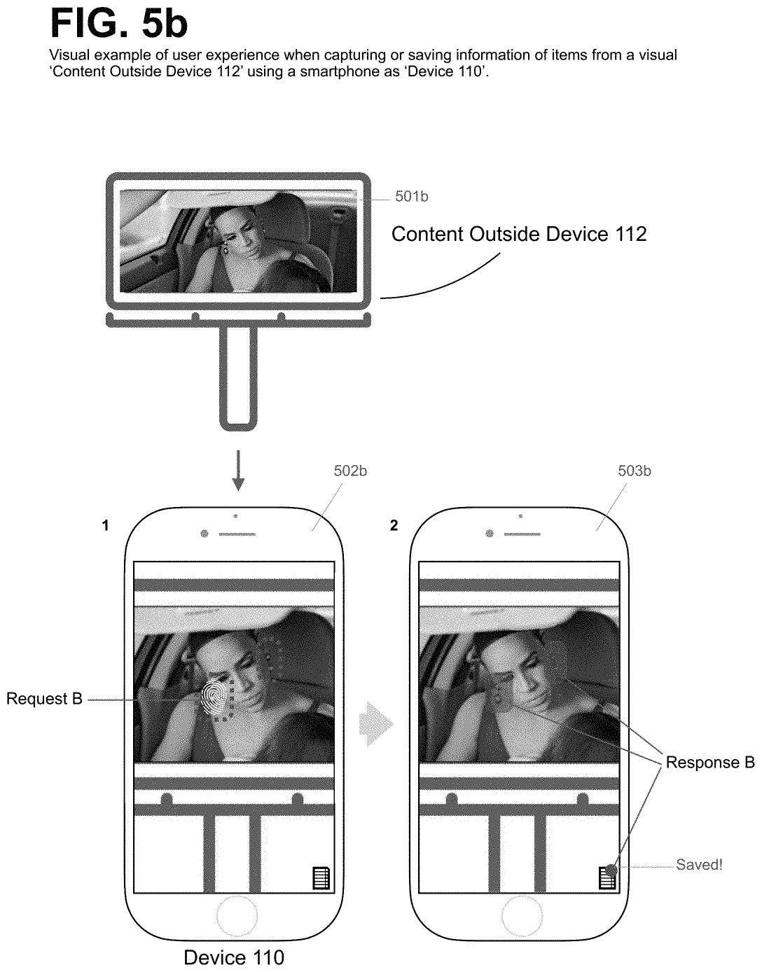

FIG. 5 represents, in the form of a flowchart, an overview of one example of a method for capturing or saving information from visual content displayed outside of the device being used. It must be noted that FIG. 5 represents an example and in no way limits any other possibility that may be induced or derived from this disclosure. For clarity we've depicted this process as Process 500 in this example. Process 500 begins with step 501 when the user of Interactive App 111 taps or presses an augmented reality experience (bounding box) thus selecting a desired item. For the purpose of this example the user has already created an account prior to this engagement, but other embodiments of the present invention may not require an account to be made or may require it later in this process or after said process. Then follows step 502 where Interactive App 111 sends Request B to the Single Access Place Module 115 within Server 103 as a consequence of the action performed in step 501. Following is step 503 where the Single Access Place Module 115 receives Request B, stores corresponding item information in the user's account in Server Database 108 and sends Response B; which for this example is a notification. Then in step 504, FIG. 5 indicates that when a time comes that the user finds convenient, the user can access Interactive App 111's item list. Afterwards, as per step 505, Interactive App 111 communicates with Single Access Place Module 115. Step 506 follows with Interactive App 111 receiving access to updated item list information. Correspondingly, the process continues with step 507 where the Interactive App 111 displays the desired item information under item list and allows user further actions such as to purchase.

FIG. 5a illustrates a visual example of utilizing a smartphone to capture or save information of items from a visual content displayed outside the device being used. It must be noted that FIG. 5a represents an example and in no way limits any other possibility that may be induced or derived from this disclosure. FIG. 5a depicts a smartphone (Device 110) with Interactive App 111 opened and a triangle or item which has been matched with Reference Content 109 and thus is surrounded by an interactive bounding box (501a). Correspondingly, FIG. 5a then shows Request B as a result of the user pressing the interactive bounding box, to which the Single Access Place Module 115 reacts to by storing corresponding item information (503a) under the user account's item list in Server Database 108 and emitting a Response B which produces a notification that indicates the item was “Saved”. At the center, FIG. 5a depicts an arrow (502a) to show that when the user finds a convenient time, he/she may open their item list by using Interactive App 111 (504a); through which the user may have the option to purchase any of the saved items.

FIG. 5b shows one possibility of a visual example of the user experience when capturing or saving information of items from a visual ‘Content Outside Device 112’ using a smartphone as ‘Device 110’. It must be noted that FIG. 5b represents an example and in no way limits any other possibility that may be induced or derived from this disclosure. As per this example, while having Interactive App 111 opened on a smartphone (502b) and aiming smartphone's camera toward Content Outside Device 112 (501b), the user presses one of the bounding boxes surrounding the desired item and produces Request B. Then Response B occurs (503b), coloring the bounding boxes around the item to give an alert or notification that Request B has been completed, as well as displaying a red dot to show that the saved item can be looked for in the item list. It must be noted that as per this example, both earrings appear colored as Response B, even though the user pressed only one of them, because they represent the same product or desired item.

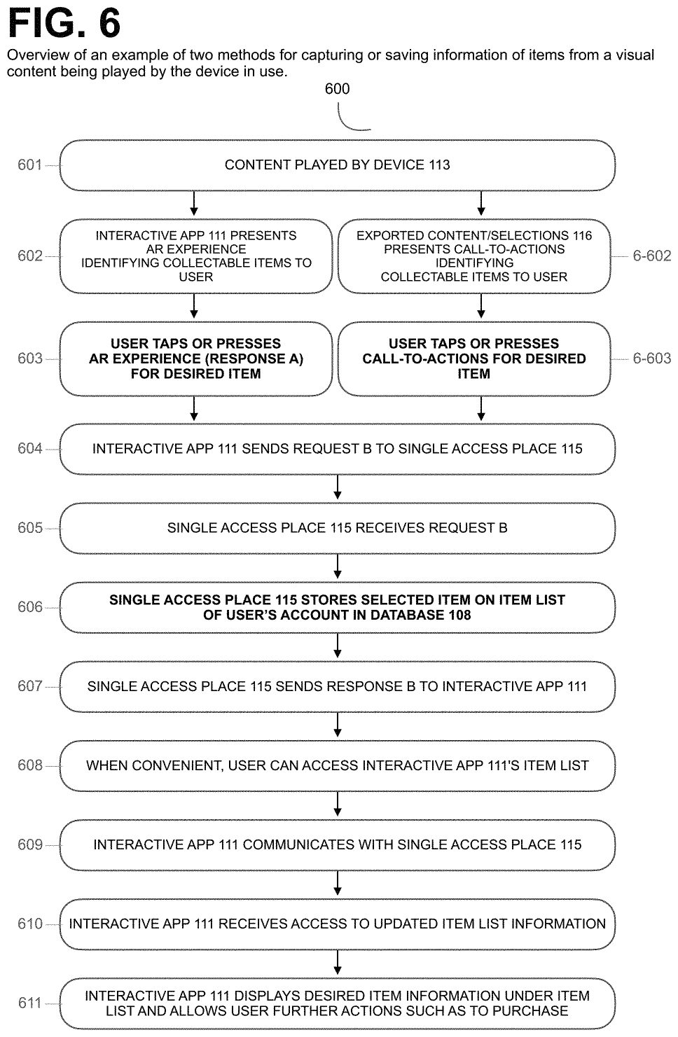

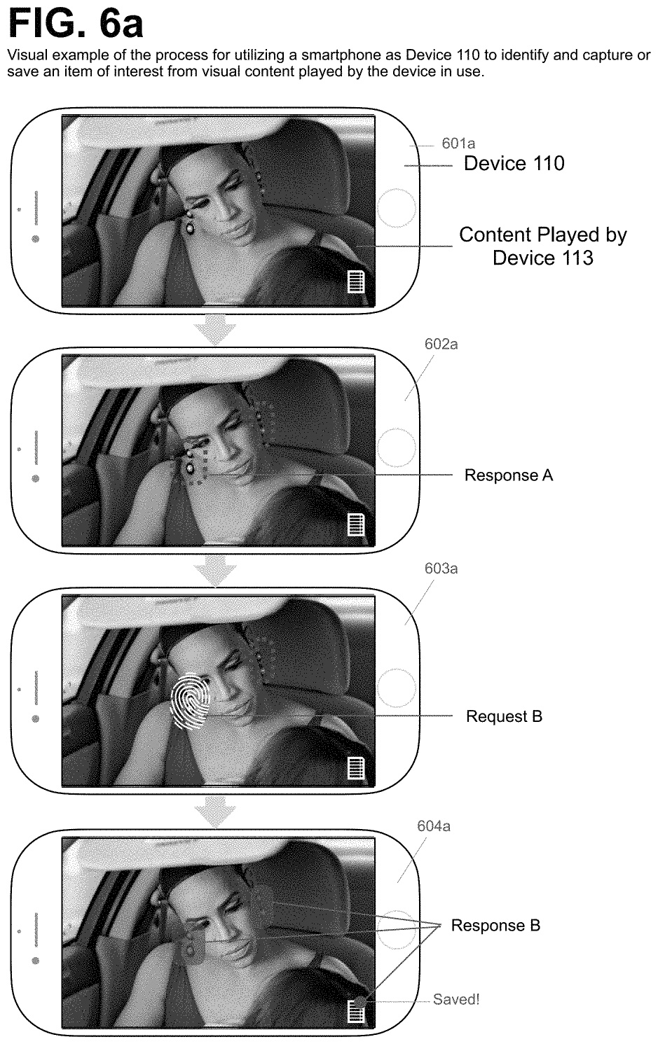

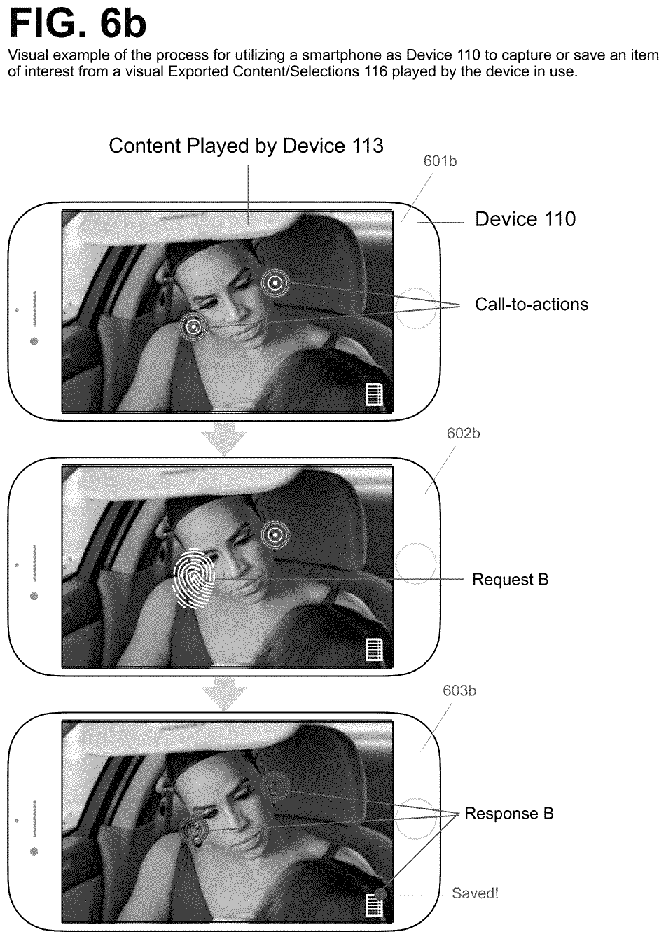

FIG. 6 represents, in the form of a flowchart, an overview of an example of two methods for capturing or saving information of items from a visual content being played by the device in use. It must be noted that FIG. 6 represents an example and in no way limits any other possibility that may be induced or derived from this disclosure. For clarity we've depicted this process as Process 600 in this example. FIG. 6 demonstrates two methods that follow the same process, except for the fact that in one method, as depicted by 602, Interactive App 111 engages Interaction Engine Module 114 in order to induce an identification process, such as image recognition or the like, to identify the collectable items showing in Content Played by Device 113 and trigger a Response A (which as per this example may be an AR experience) versus the other method (as depicted by 6-602) where Interactive App 111 runs or plays an Exported Content/Selections 116 as, or in conjunction with, Content Played by Device 113 in order to show call-to-actions identifying collectable items to user. Then, depending on the method used, the user follows either step 603 and/or 6-603, resulting in the user of Interactive App 111 tapping/pressing the Augmented Reality experience (603) or the call-to-action (6-603) that identifies the desired item. For the purpose of this example the user has already created an account prior to this engagement, but other embodiments of the present invention may not require an account to be made or may require it later in this process or after said process. Then follows step 604 where Interactive App 111 sends Request B to Single Access Place Module 115 as a consequence of the action performed in steps 603 and/or 6-603. Following is step 605 where Single Access Place Module 115 receives Request B, and then step 606 where Single Access Place Module 115 stores selected item information on an item list within the user's account in Server Database 108. Afterwards, FIG. 6 illustrates step 607 where Single Access Place Module 115 sends Response B to Interactive App 111. Then in step 608, FIG. 6 indicates that when a time comes that the user finds convenient, the user of Interactive App 111 may access the item list under his/her account. Next, as per step 609, Interactive App 111 communicates with Single Access Place Module 115 so that the user may have access to an updated item list as stated in step 610. Correspondingly, step 611 follows with the Interactive App 111 displaying desired item information under an item list and allowing the user further actions such as to purchase.

FIG. 6a shows one possibility of a visual example of the process for utilizing a smartphone as Device 110 to identify and capture or save an item of interest from visual content played by the device in use. It must be noted that FIG. 6a represents an example and in no way limits any other possibility that may be induced or derived from this disclosure. FIG. 6a first depicts a smartphone (601a) as Device 110 and demonstrates an example of Content Played by Device 113. Below it shows the same image (602a) but with bounding boxes surrounding items thus indicating that an image recognition process has taken place to produce a Response A (bounding box) in the Interactive App 111. Then follows 603a, showing a fingerprint over one of the bounding boxes to illustrate that the user of Interactive App 111 has pressed it with the intention to save the item, causing the app to induce Request B. At the bottom of FIG. 6a is image 604a illustrating colored bounding boxes (Response B) as an alert or notification indicating that Request B has been completed and that the item has been saved. It must be noted that as per this example, both earrings appear colored as Response B, even though the user pressed only one of them, because they represent the same product or desired item. In terms of user experience, FIG. 6a represents the following process as a possible example in one embodiment of the present invention. When a user of Device 110 plays Content Played by Device 113, a process of identification (such as image recognition) is executed by Interactive App 111 resulting in the appearance of bounding boxes surrounding interactive items. The user may proceed to save the desired item by pressing one of the bounding boxes. This action will color the bounding box, as well as any other bounding box representing the same item, as a notification that the item has been saved into his/her account; as well as display a red dot in the items list icon to show that the saved item can be looked for in the item list.

FIG. 6b illustrates a visual example of the process for utilizing a smartphone as Device 110 to capture or save an item of interest from a visual Exported Content/Selections 116 played by the device in use. It must be noted that FIG. 6b represents an example and in no way limits any other possibility that may be induced or derived from this disclosure. FIG. 6b first depicts a smartphone (601b) as Device 110 and demonstrates an example of a visual Content Played by Device 113. In the same image (601b) it shows call-to-actions over some items signifying that Content Played by Device 113 is running/streaming/playing as, or in conjunction with, an Exported Content/Selection 116. Then follows 602b, showing a fingerprint over one of the call-to-actions to illustrate that the user of Interactive App 111 has pressed it with the intention to save the item, causing the app to induce Request B. At the bottom of FIG. 6b is image 603b illustrating colored call-to-actions (Response B) as an alert or notification indicating that Request B has been completed and that the item has been saved. It must be noted that as per this example, both earrings appear colored as Response B, even though the user pressed only one of them, because they represent the same product or desired item. In terms of user experience, FIG. 6b represents the following process as a possible example in one embodiment of the present invention. When the user of Interactive App 111 plays Content Played by Device 113, the Interactive App 111 communicates with the Single Access Place Module 115 to run/stream/play Exported Content/Selections 116 as, or in conjunction with, Content Played by Device 113. As Content Played by Device 113 is played, the user may see call-to-actions over specific items. The user may proceed to save the desired item by pressing one of the call-to-actions. This action will color the call-to-action, as well as any other call-to-action representing the same item, as a notification that the item has been saved into his/her account; as well as display a red dot in the items list icon to show that the saved item can be looked for in the item list.

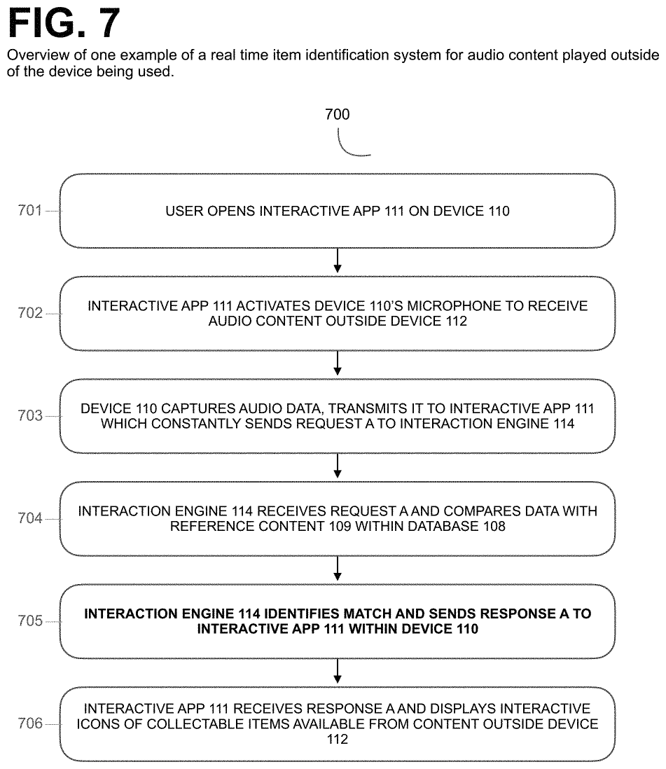

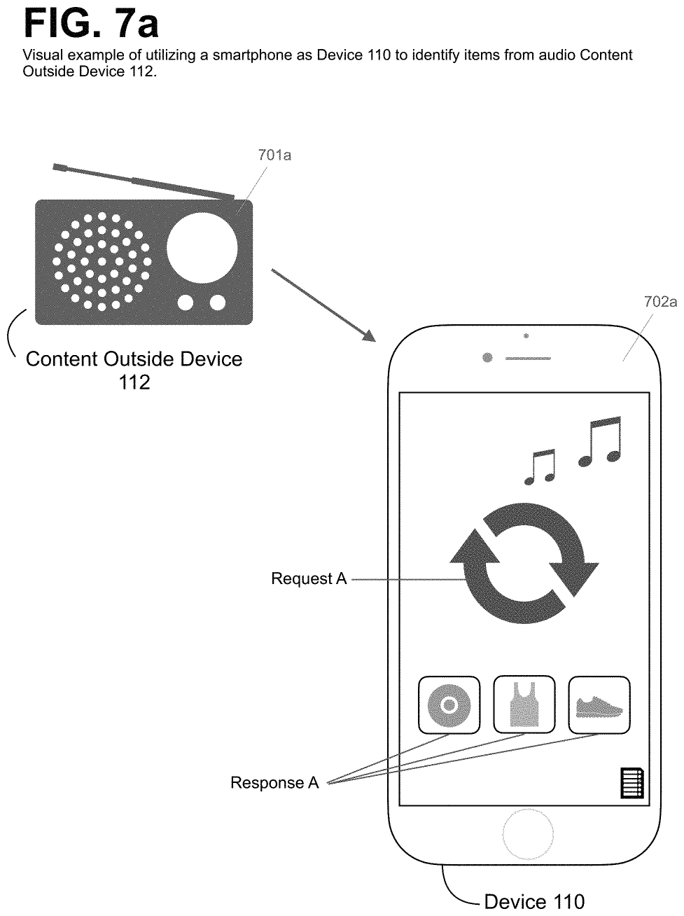

FIG. 7 represents, in the form of a flowchart, an overview of one example of a real time item identification system for audio content played outside of the device being used. It must be noted that FIG. 7 represents an example and in no way limits any other possibility that may be induced or derived from this disclosure. For clarity we've depicted this process as Process 700 in this example. Process 700 begins with the user opening the Interactive App 111 on Device 110 as established in step 701. For the purpose of this example, the user has already created an account prior to this engagement, but other embodiments of the present invention may not require an account to be made or may require it later in this process or after said process. Then follows step 702 where Interactive App 111 (or the user in some embodiments of the invention) activates the Device 110's microphone to receive audio Content Outside Device 112. Following is step 703 where Device 110 reads or captures audio data and transmits it to Interactive App 111, which constantly sends Request A to Interaction Engine Module 114. Then in step 704 Interaction Engine Module 114 receives Request A and compares the audio data with Reference Content 109 within Server Database 108. Afterwards, as per step 705, when Interaction Engine Module 114 identifies a match, it sends Response A to Interactive App 111 within Device 110. Step 706 follows, where Interactive App 111, within Device 110, receives Response A and displays interactive icons of the collectable items available from Content Outside Device 112.

FIG. 7a illustrates a visual example of utilizing a smartphone as Device 110 to identify items from audio Content Outside Device 112. It must be noted that FIG. 7a represents an example and in no way limits any other possibility that may be induced or derived from this disclosure. First, FIG. 7a depicts a radio (701a) playing an audio Content Outside Device 112. Following this, FIG. 7a shows an arrow pointing to a smartphone (702a) to show that the audio content is being captured by Device 110. Within the smartphone display screen FIG. 7a shows two curved arrows forming a circle thus indicating that an audio recognition process has taken place to produce a Response A in the Interactive App 111. Within the same image interactive icons of collectable items are shown at the bottom part of the display screen to illustrate the outcome of Response A. In terms of user experience, FIG. 7a represents the following process as a possible example in one embodiment of the present invention. When a user hears a song from a Content Outside Device 112, he/she may use the Interactive App 111 to identify, through audio recognition, collectable items designated to the song. As a result, the app then shows interactive icons representing those items.

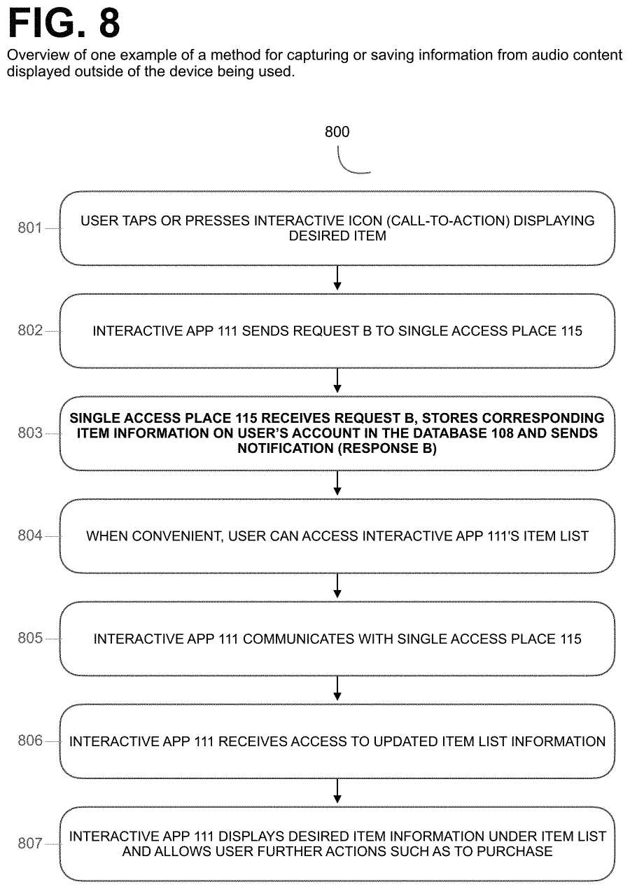

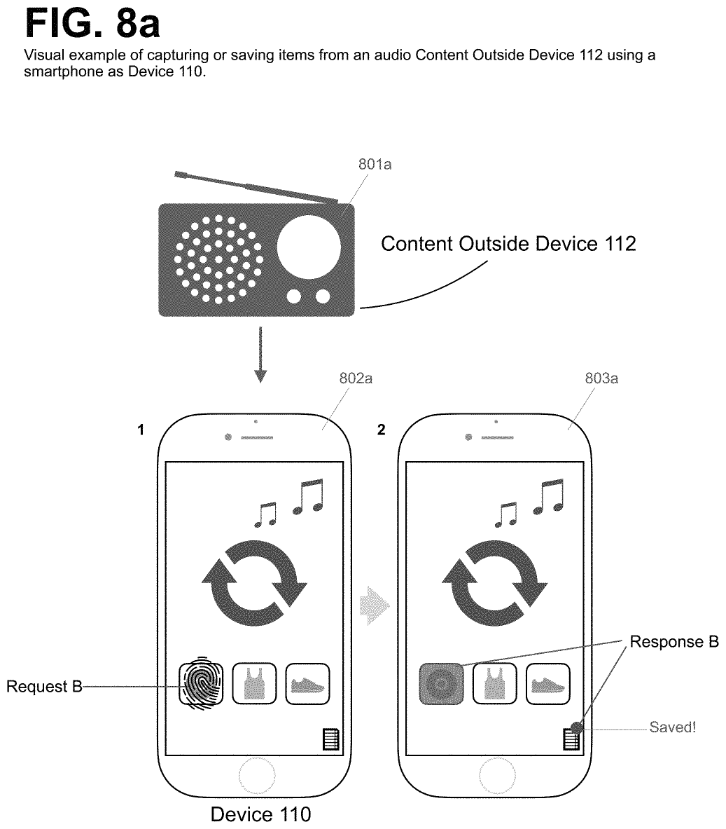

FIG. 8 represents, in the form of a flowchart, an overview of one example of a method for capturing or saving information from audio content displayed outside of the device being used. It must be noted that FIG. 8 represents an example and in no way limits any other possibility that may be induced or derived from this disclosure. For clarity we've depicted this process as Process 800 in this example. Process 800 begins with step 801 when the user of Interactive App 111 taps or presses the interactive icon of a desired collectable item. For the purpose of this example the user has already created an account prior to this engagement, but other embodiments of the present invention may not require an account to be made or may require it later in this process or after said process. Then follows step 802 where Interactive App 111 sends Request B to the Single Access Place Module 115, within Server 103, as a consequence of the action performed in step 801. Following is step 803 where the Single Access Place Module 115 receives Request B, stores corresponding item information in the user's account in Server Database 108 and sends Response B; which for this example is a notification. Then in step 804, FIG. 8 indicates that when a time comes that the user finds convenient, the user can access Interactive App 111's item list. Afterwards, as per step 805, Interactive App 111 communicates with Single Access Place Module 115. Step 806 follows with Interactive App 111 receiving access to updated item list information. Correspondingly, the process continues with step 807 where the Interactive App 111 displays the desired item information under item list and allows user further actions such as to purchase.

FIG. 8a illustrates a visual example of capturing or saving items from an audio Content Outside Device 112 using a smartphone as Device 110. It must be noted that FIG. 8a represents an example and in no way limits any other possibility that may be induced or derived from this disclosure. FIG. 8a depicts a radio (801a) playing an audio Content Outside Device 112. Following this, FIG. 8a shows an arrow pointing to a smartphone (802a) with two curved arrows forming a circle thus indicating that an audio recognition process has taken place to produce a Response A in the Interactive App 111. Within the same image, interactive icons of collectable items are shown at the bottom part of the display screen to illustrate the outcome of Response A and one of them shows a fingerprint over it to illustrate that the user of Interactive App 111 has pressed it with the intention to save the item, causing the app to induce Request B. Next, image 803a illustrates the interactive icon of the collected item colored (Response B) as an alert or notification indicating that Request B has been completed and that the item has been saved. In terms of user experience, FIG. 8a represents the following process as a possible example in one embodiment of the present invention. When a user hears a song from a Content Outside Device 112, he/she may use the Interactive App 111 to identify, through audio recognition, collectable items designated to the song. As a result, the app then shows interactive icons representing those items. The user may proceed to save a desired item by pressing one of the interactive icons. This action will color the interactive icon as a notification that the collected item has been saved into his/her account; as well as display a red dot in the items list icon to show that the saved item can be looked for in the item list.

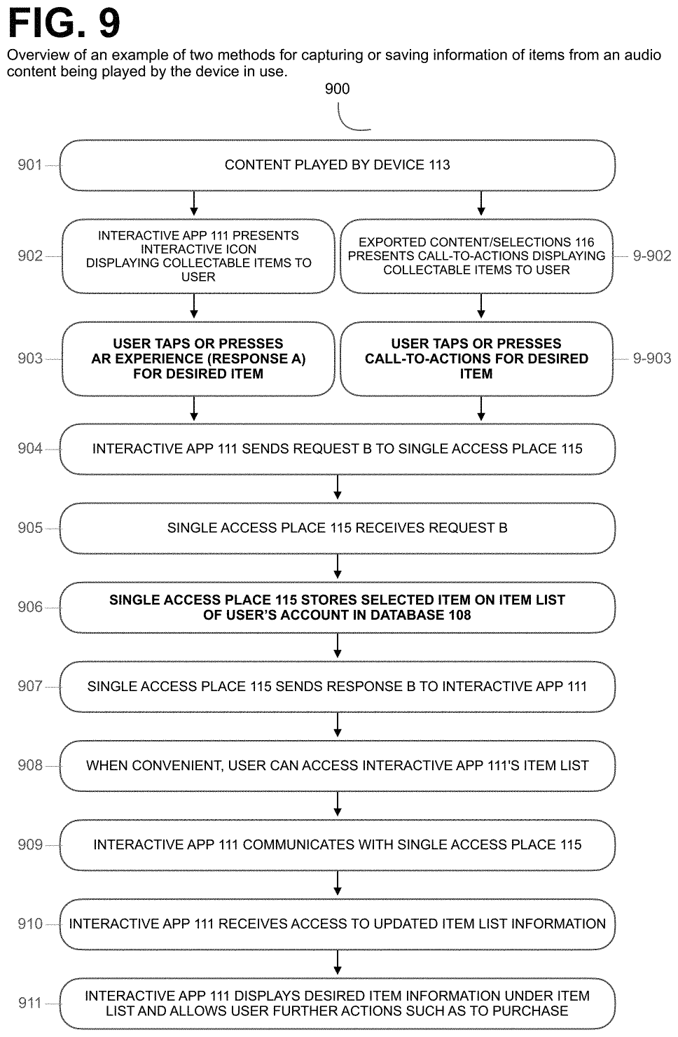

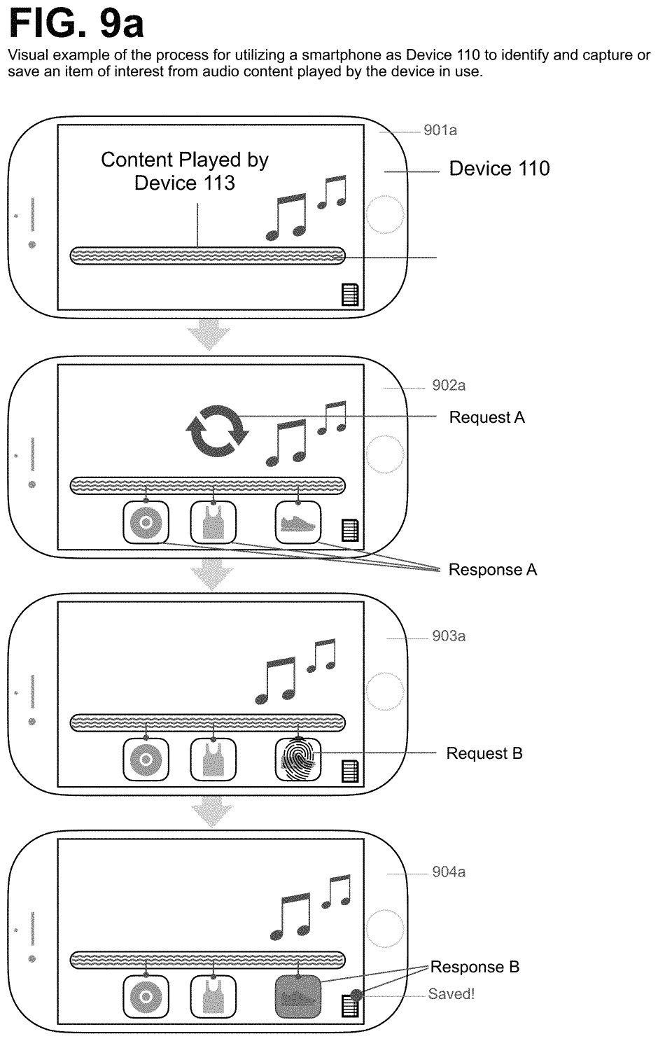

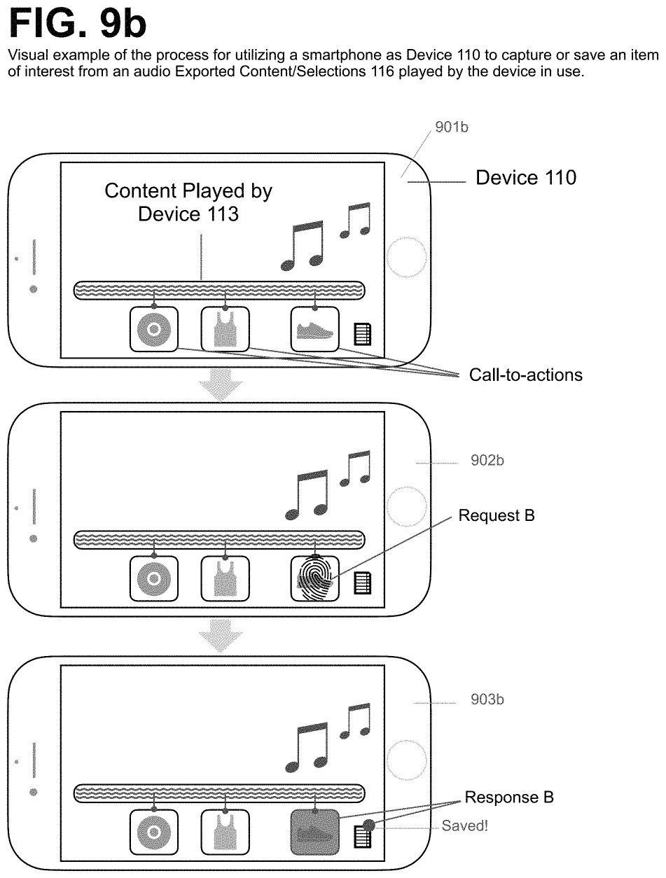

FIG. 9 represents, in the form of a flowchart, an overview of an example of two methods for capturing or saving information of items from an audio content being played by the device in use. It must be noted that FIG. 9 represents an example and in no way limits any other possibility that may be induced or derived from this disclosure. For clarity we've depicted this process as process 900 in this example. FIG. 9 demonstrates two methods that follow the same process, except for the fact that in one method, as depicted by 902, Interactive App 111 engages Interaction Engine Module 114 in order to induce an identification process, such as audio recognition or the like, to display interactive icons of collectable items available in Content Played by Device 113 (Response A) versus the other method (as depicted by 9-902) where Interactive App 111 runs or plays an Exported Content/Selections 116 as, or in conjunction with, Content Played by Device 113 in order to show call-to-actions displaying collectable items. Then, depending on the method used, the user follows either step 903 and/or 9-903, resulting in the user of Interactive App 111 tapping/pressing the interactive icon (903) or the call-to-action (9-903) that displays the desired collectable item. For the purpose of this example the user has already created an account prior to this engagement, but other embodiments of the present invention may not require an account to be made or may require it later in this process or after said process. Then follows step 904 where Interactive App 111 sends Request B to Single Access Place Module 115 as a consequence of the action performed in steps 903 and/or 9-903. Following is step 905 where Single Access Place Module 115 receives Request B, and then step 906 where Single Access Place Module 115 stores selected item information on an item list within the user's account in Server Database 108. Afterwards, FIG. 9 illustrates step 907 where Single Access Place Module 115 sends Response B to Interactive App 111. Then in step 908, FIG. 9 indicates that when a time comes that the user finds convenient, the user of Interactive App 111 may access the item list under his/her account. Next, as per step 909, Interactive App 111 communicates with Single Access Place Module 115 so that the user may have access to an updated item list as stated in step 910. Correspondingly, step 911 follows with the Interactive App 111 displaying desired item information under an item list and allowing the user further actions such as to purchase.

FIG. 9a shows one possibility of a visual example of the process for utilizing a smartphone as Device 110 to identify and capture or save an item of interest from audio content played by the device in use. It must be noted that FIG. 9a represents an example and in no way limits any other possibility that may be induced or derived from this disclosure. FIG. 9a first depicts a smartphone (901a) as Device 110 and demonstrates an example of an audio Content Played by Device 113. Below it shows the same image (902a) but with two curved arrows forming a circle thus indicating that an audio recognition process has taken place to produce a Response A in the Interactive App 111. Within the same image interactive icons of collectable items are shown at the bottom part of the display screen to illustrate the outcome of Response A. Then follows 903a, showing a fingerprint over one of the interactive icons of collectable items to illustrate that the user of Interactive App 111 has pressed it with the intention to save the item, causing the app to induce Request B. At the bottom of FIG. 9a is image 904a illustrating the interactive icon of the collected item colored (Response B) as an alert or notification indicating that Request B has been completed and that the item has been saved. In terms of user experience, FIG. 9a represents the following process as a possible example in one embodiment of the present invention. When a user of Device 110 plays audio Content Played by Device 113, a process of identification (such as audio recognition) is executed by Interactive App 111 resulting in the appearance of interactive icons of collectable items. The user may proceed to save a desired item by pressing one of the interactive icons. This action will color the interactive icon as a notification that the collected item has been saved into his/her account; as well as display a red dot in the items list icon to show that the saved item can be looked for in the item list.

FIG. 9b illustrates a visual example of the process for utilizing a smartphone as Device 110 to capture or save an item of interest from an audio Exported Content/Selections 116 played by the device in use. It must be noted that FIG. 9b represents an example and in no way limits any other possibility that may be induced or derived from this disclosure. FIG. 9b first depicts a smartphone (901b) as Device 110 and demonstrates an example of an audio Content Played by Device 113. In the same image (901b) it shows call-to-actions displaying collectable items signifying that Content Played by Device 113 is running/streaming/playing as, or in conjunction with, an Exported Content/Selection 116. Then follows 902b, showing a fingerprint over one of the call-to-actions to illustrate that the user of Interactive App 111 has pressed it with the intention to save the item, causing the app to induce Request B. At the bottom of FIG. 9b is image 903b illustrating the call-to-action of the collected item colored (Response B) as an alert or notification indicating that Request B has been completed and that the item has been saved; as well as displaying a red dot in the items list icon to show that the saved item can be looked for in the item list.

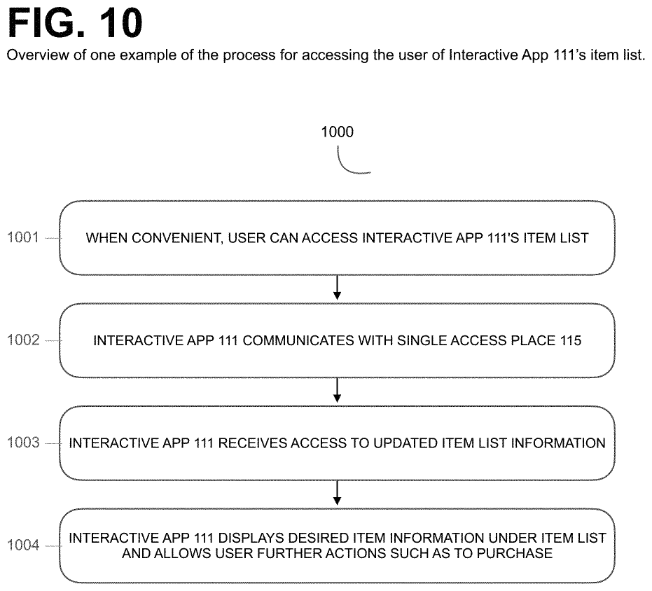

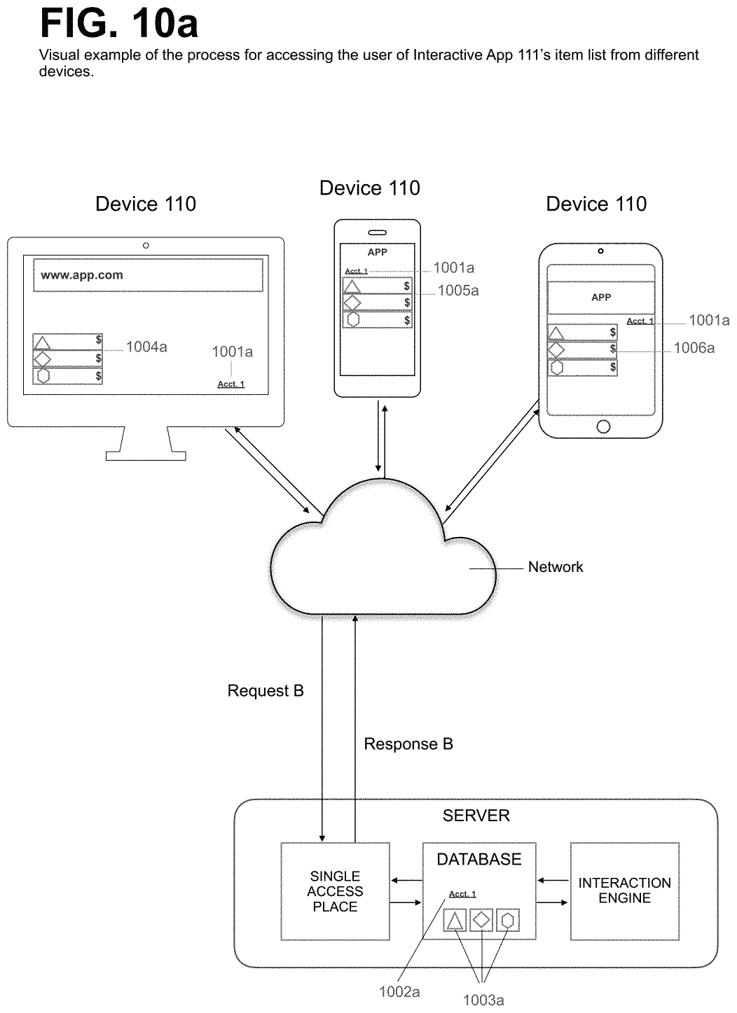

FIG. 10 represents, in the form of a flowchart, an overview of one example of the process for accessing the user of Interactive App 111's item list. It must be noted that FIG. 10 represents an example and in no way limits any other possibility that may be induced or derived from this disclosure. For clarity we've depicted this process as Process 1000 in this example. Process 1000 begins with step 1001 that states that when a time comes that the user finds convenient, the user of Interactive App 111 may access the item list under his/her account. Next, as per step 1002, Interactive App 111 communicates with Single Access Place Module 115 so that the user may have access to an updated item list as stated in step 1003. Correspondingly, step 1004 follows with the Interactive App 111 displaying desired item information under an item list and allowing the user further actions such as to purchase.

FIG. 10a illustrates a visual example of the process for accessing the user of Interactive App 111's item list from different devices. It must be noted that FIG. 10a represents an example and in no way limits any other possibility that may be induced or derived from this disclosure. FIG. 10a depicts multiple devices that may be used as Device 110 by a user of Interactive App 111 to access his/her account's item list. As can be seen in FIG. 10a, all are connected to Account 1 (1001a) and have arrows pointing to and coming from a network to indicate that all may use a network (e.g. the internet) to communicate with the Single Access Place Module 115 within Server 103. Additionally, an arrow is shown pointing from the network to the Single Access Place Module 115 titled Request B to imply that, independently of whichever Device 110 is used, a request for the user of Interactive App 111's updated item list information (Request B) may be made through the network to the Single Access Place Module 115. Correspondingly, back & forth arrows are shown from Single Access Place Module 115 to Server Database 108 (which holds the item list information labeled 1003a) to imply that Single Access Place Module 115 retrieves Account 1's (1002a) updated item list information from the database. In addition, an arrow pointing from the Single Access Place Module 115 to the network is shown to imply that the updated item list information is communicated by the Single Access Place Module 115 back to the Device 110 in use through the network. FIG. 10a serves to demonstrate that, in some embodiments of the invention, users of Interactive App 111 may not be limited to one Device 110 to access the information they have stored (including items saved) in their accounts from the interactions made. Therefore, they may change the Device 110 (e.g. desktop, smartphone, tablet, etc.) as long as it can run Interactive App 111 and communicate with Single Access Place Module 115 to gain access to their account information within Server Database 108.

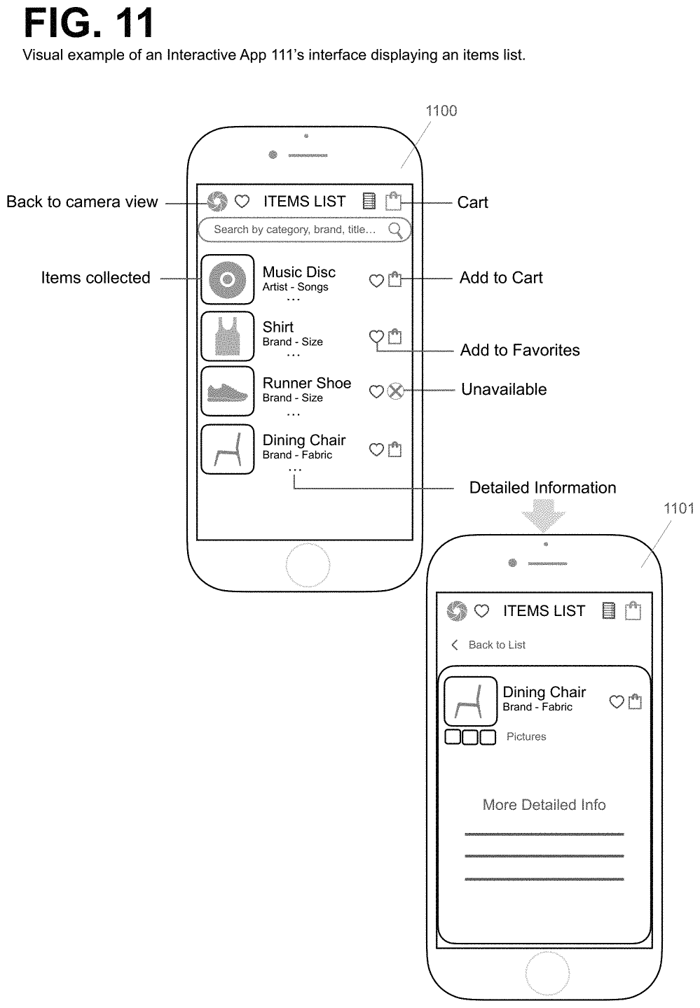

FIG. 11 is a visual example of Interactive App 111's interface displaying an items list. It must be noted that FIG. 11 represents an example and in no way limits any other possibility that may be induced or derived from this disclosure. FIG. 11 first depicts a smartphone (1100) as Device 110 with the display screen showing an item list within Interactive App 111 to serve as an example of what the interface for accessing saved items and detailed information might look like in one embodiment of the present invention. Within this interface, FIG. 11 shows a list of items collected; an icon at the top left corner that represents an option for returning to camera view; an icon of a large shopping bag in the top left corner of the display screen which represents an option to head to cart; smaller shopping bags below that represent the option to add items to cart; heart icons that represent the option to add items to favorites; an icon of a circled X which represents a visual indication that an icon is no longer available; and information next to each icon with an option to obtain further detailed information. Below is image 1101 which shows the same smartphone displaying how a detailed Information window may look like if item information on the item list is pressed or activated in one example of one embodiment of the present invention.

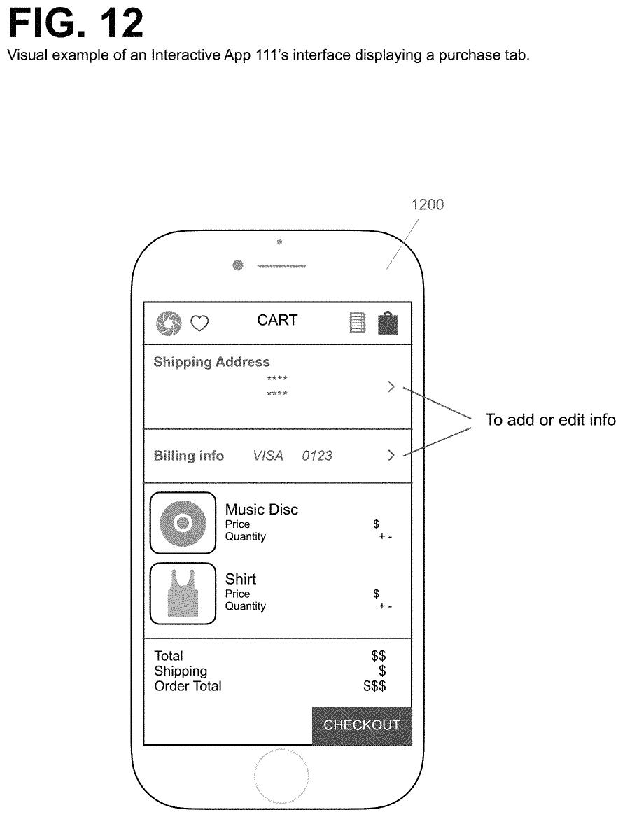

FIG. 12 is a visual example of Interactive App 111's interface displaying a purchase tab. It must be noted that FIG. 12 represents an example and in no way limits any other possibility that may be induced or derived from this disclosure. FIG. 12 depicts a smartphone (1200) as Device 110 with the display screen showing an example of how the purchase tab of Interactive App 111 might look like in one embodiment of the present invention. As per this example, the purchase tab may include: shipping address and billing information that may be editable directly from this tab; the items selected for purchase with pertinent information such as name, quantity and price; a sub-total, shipping costs and an order Total; as well as a checkout or purchase button.

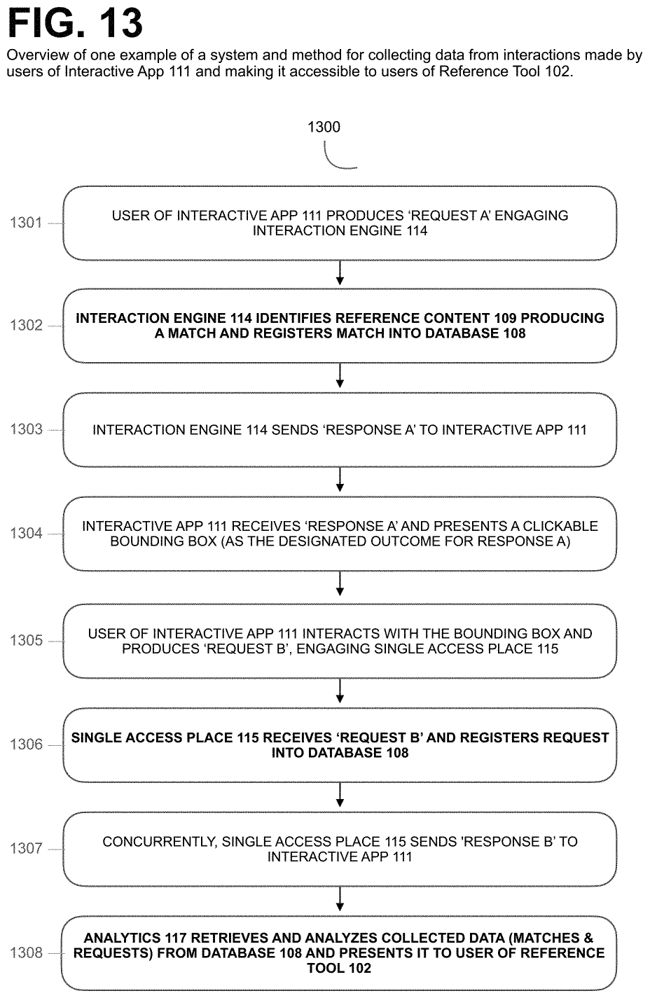

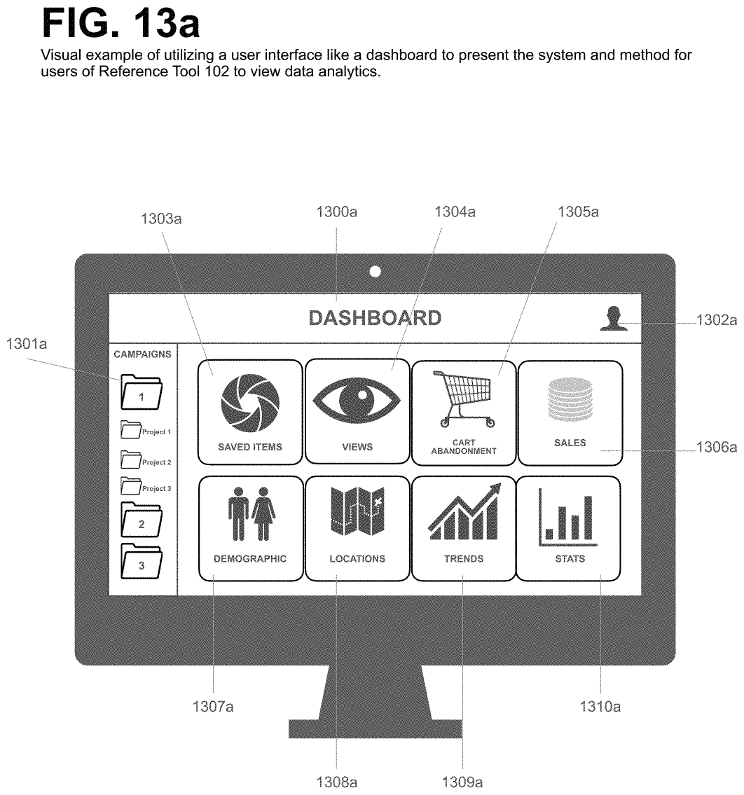

FIG. 13 represents, in the form of a flowchart, an overview of one example of a system and method for collecting data from interactions made by users of Interactive App 111 and making it accessible to users of Reference Tool or Module 102. It must be noted that FIG. 13 represents an example and in no way limits any other possibility that may be induced or derived from this disclosure. For clarity we've depicted this process as Process 1300 in this example. Process 1300 begins when the user of Interactive App 111 produces ‘Request A’ thus engaging Interaction Engine Module 114 as stated in step 1301. Following, is step 1302 in which Interaction Engine Module 114 identifies a match with Reference Content 109 and registers the match into Server Database 108. Accordingly, Interaction Engine Module 114 sends ‘Response A’ to Interactive App 111, as indicated by step 1303. Correspondingly, as stated in step 1304, Interactive App 111 receives Response A and presents a clickable bounding box as the designated outcome for Response A. Then, as per step 1305 of FIG. 13, the user of Interactive App 111 interacts with the bounding box and produces ‘Request B’ thus engaging Single Access Place Module 115. When Single Access Place Module 115 receives ‘Request B’, it registers the request into Server Database 108 as stated in step 1306. Concurrently, Single Access Place Module 115 sends ‘Response B’ to Interactive App 111 as stated in step 1307. Ultimately, as per step 1308, Analytics Module 117 may systematically (or when requested) retrieve and analyze collected data (e.g. matches and Interactive App 111's requests) from Server Database 108 and present it to users of Reference Tool or Module 102 so that they can study it and utilize it for their convenience.

FIG. 13a is a visual example of utilizing a user interface like a dashboard to present the system and method for users of Reference Tool or Module 102 to view data analytics. It must be noted that FIG. 13a represents an example and in no way limits any other possibility that may be induced or derived from this disclosure. FIG. 13a depicts, in one embodiment of the present invention, a monitor or screen which displays a dashboard (1300a) with many tiles; as to represent different types of information or analytics that can be accessed through this Tool or Module. As per this example, and in some embodiments of the proposed system and method, some of the information that could be obtained regarding the present invention may relate to: saved items (1303a) which may be obtained from the registered Request B; views (1304a) which may be obtained from the registered Response A; cart abandonment (1305a), sales data (1306a) & app's user demographics (1307a) which may be obtained from the user's account by means of the Single Access Place Module 115; location information (1308a) which may be obtained with geolocation from the interactions made by means of Interactive App 111; trends (1309a) and statistics (1310a) which may be obtained from the analyzes made by Analytics Module 117. FIG. 13a also depicts a folder and file system (1301a) based on campaigns and projects and an account icon for accessing account information and/or settings (1302a). In terms of user experience, FIG. 13a represents the following process as a possible example in one embodiment of the present invention. The user opens Reference Tool or Module 102 via a web browser and enters into his/her account. Accordingly, the user has access to an organized and user friendly dashboard that provides similar information to the one depicted in FIG. 13a. Correspondingly, the user of Reference Tool or Module 102 utilizes this information to make informed business decisions relevant to the information provided (e.g. increase or decrease a type of advertising in a certain location and/or for a certain product or products).

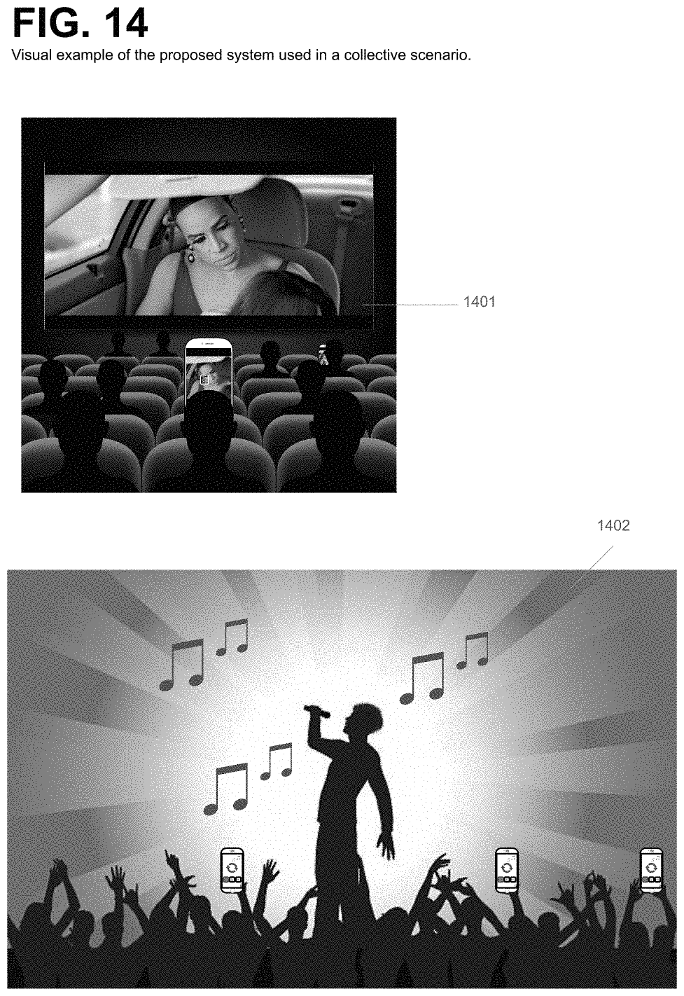

FIG. 14 illustrates a visual example of the proposed system used in a collective scenario. It must be noted that FIG. 14 represents an example and in no way limits any other possibility that may be induced or derived from this disclosure. FIG. 14 shows two examples of possible collective scenarios (images 1401 & 1402) depicting users of Device 110 utilizing Interactive App 111 during those experiences. In FIG. 14 it can be seen that the illustration 1401 represents a movie theater and illustration 1402 a live concert or performance; yet it must not be interpreted as limiting the use of the proposed system to only these two collective scenarios. For example, in some embodiments of the proposed system, live theaters, sports establishments & stadiums, family rooms with TVs or computer screens and any other collective scenario which allows for viewing, hearing, or experiencing interactive content may serve as the setting for the proposed interactive experiences.

In terms of user experience, FIG. 14 represents the following processes as possible examples in some embodiments of the present invention. In image 1401, an individual in a movie theater watches a movie that is interactive (Content Outside Device 112). When he/she sees a desired item with a call to action that indicates that items are interactive, he/she, having Interactive App 111 open, points Device 110s camera (e.g. smartphone's camera) toward the content on the screen (Content Outside Device 112). Device 110 instantly identifies the content and continually transmits these captures to Interactive App 111 which sends Request A to Interaction Engine Module 114. When Interaction Engine Module 114 identifies a match with Reference Content 109 it sends Response A allowing the viewer to see on Interactive App 111 an augmented reality experience like a bounding box surrounding items within the content that the Device 110's camera is focused on. When the user of Interactive App 111 sees a bounding box around a desired item, he/she can press it (Request B) to save the item into his/her account. Server 103 receives Request B by means of Single Access Place Module 115, and correspondingly stores the item with its detailed information into the user's account; then sends Response B to Interactive App 111 which manifests by coloring the bounding box. This colored box alerts the user of Interactive App 111 that the item and its related information have been saved into his/her account.

In image 1402, an individual at a concert hears a song that has been announced to be interactive. He/she takes out a smartphone (Device 110), logs into his/her account on Interactive App 111 and activates Device 110's microphone. Device 110 continually transmits audio captures to Interactive App 111, which sends it to Interaction Engine Module 114 as Request A via the internet. When Interaction Engine Module 114 detects a match with Reference Content 109, it sends response A to Interactive App 111 which shows a list of interactive icons representing items, information or offers. Correspondingly, the user presses the interactive items he/she desires sending Request B to Single Access Place Module 115. Accordingly, Server 103 stores the item with its detailed information into the user's account; then sends Response B to Interactive App 111 which manifests by coloring the interactive icons. This coloring alerts the user of Interactive App 111 that the item and its related information have been saved into his/her account.

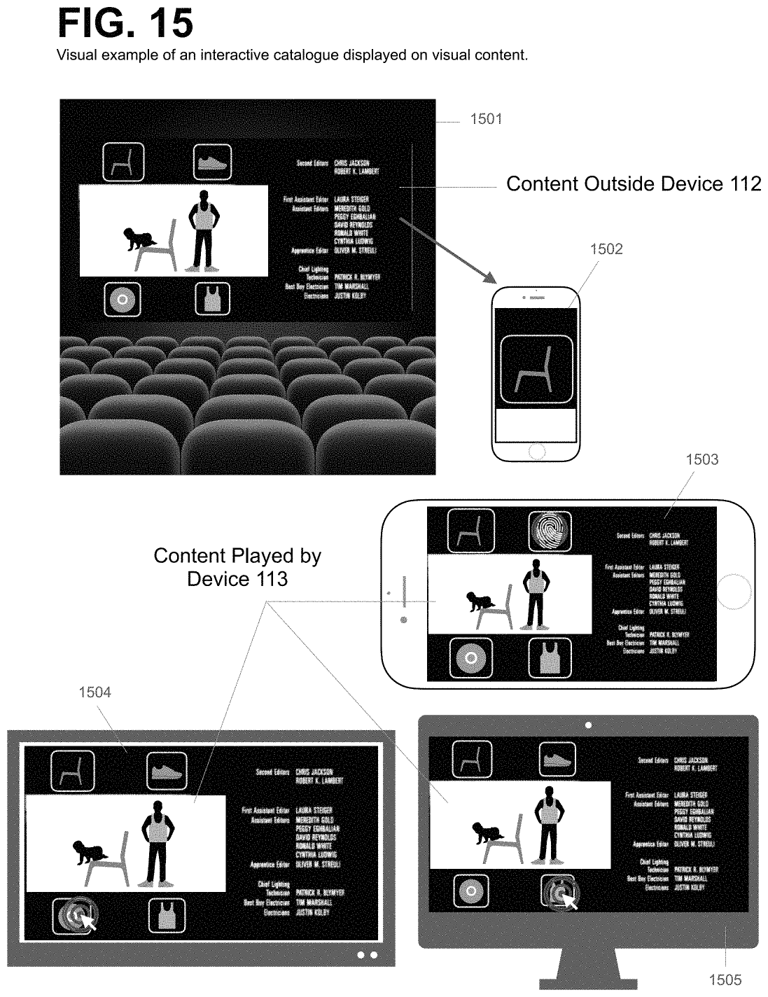

FIG. 15 is a visual example of an interactive catalogue displayed on visual content. It must be noted that FIG. 15 represents an example and in no way limits any other possibility that may be induced or derived from this disclosure. FIG. 15 depicts several examples of an interactive catalogue displayed on visual content through different platforms; for both Content Outside Device 112 as shown in illustration 1501 or Content Played by Device 113 as shown by illustrations 1503, 1504, & 1505. For further clarification, in this example 1501 points to illustration 1502 which depicts a Device 110 or smartphone with a chair in its display screen to propose the possibility that an item in Content Outside Device 112 had been detected by the device. Furthermore, illustrations 1503, 1504 & 1505 have a cursor or fingerprint above some items to address the possibility of interaction with the items in the catalogue through various platforms. In several of the embodiments of the invention and/or any of the processes mentioned in this disclosure, an interactive catalogue may be prepared as an organized way to allow for interactivity with items from or alluded to by visual, audio and/or other forms of sensory content or experiences in order to obtain easy access to information, additional content and/or the exercising of further actions such as purchases. Additionally, it must be noted that, in other embodiments of the present invention, interactive catalogues may take different forms, such as but not limited to audio lists. Also, in several embodiments of the present invention, the timing or use of these interactive catalogues is not limited to the end or beginning of the content, rather it may be used at anytime and anywhere the owner of the content (user of Reference Tool or Module 102) considers adequate or desires; and may even serve as the sole content. Moreover, interactive catalogues may be used in any type of platform or through any channel, including but not limited to print.

Although the present invention has been described herein with reference to the foregoing exemplary embodiment, this embodiment does not serve to limit the scope of the present invention. Accordingly, those skilled in the art to which the present invention pertains will appreciate that various modifications are possible, without departing from the technical spirit of the present invention.

1. An interactive multimedia management system for enhancing a user experience comprising:
a reference tool module receiving media of interest from a content provider and generating reference content associated to said media of interest, detailed information related to said reference content and at least one outcome associated to the reference content;
a server database storing said reference content, said detailed information and said at least one outcome;
an interaction server module receiving from a user device an interaction request including media associated to said user device, wherein said interaction server module compares the media associated to said user device with the reference content on said server database, and sends to the user device an interaction response when said reference content is matched to content on the media associated to said user device; and
a single access module receiving from said reference tool module the generated reference content for storage on said server database, wherein said single access module further receives from said user device a single access interaction request based on said interaction response and sends to said user device a single access interaction response based on said single access interaction request.

2. The interactive multimedia management system according to claim 1, wherein said reference tool module comprises a selection module that selects content from the media of interest and generates said reference content.

3. The interactive multimedia management system according to claim 2, further comprising an automatic selection module that selects the content automatically, wherein said content is selected by said automatic selection module, manually by the content provider or a combination thereof.

4. The interactive multimedia management system according to claim 3, wherein the content selected automatically is deselected by said content provider via the selection module.

5. The interactive multimedia management system according to claim 1, wherein said reference tool module comprises a designation module that generates said detailed information and said at least one outcome.

6. The interactive multimedia management system according to claim 1, wherein the interaction response sent to the user device includes at least one of: said detailed information or said at least one outcome.

7. The interactive multimedia management system according to claim 1, wherein said detailed information comprises at least one of: a product information, a service information, a product specifications, a service specification, a brand, a product name, a service name, a manufacturer name, a model number, a color, a size, a type, a title, a description, keywords, images, prices, a product option, a service option, delivery options, shipping details, payment options, donation options, discount options, offers, promotions, news, locations, biographies, filmographies, videos, movie trailers, behind-the-scenes videos, deleted scenes videos, post-credits scenes video, directors' cuts video, graphics, 2D models, 3D models, animations, audio, music, voice over, vibrations.

8. The interactive multimedia management system according to claim 1, wherein said detailed information is provided as at least one of: an audio file, an image file, a video file, a URL, a hyperlink, image data, video data, audio data, textual data, metadata, numerical data, symbols, program coding language, an audio/visual/sensory representation thereof.

9. The interactive multimedia management system according to claim 1, wherein said at least one outcome comprises at least one of: a visual experience, an audio experience, a sensory experience, an augmented reality experience, displaying a video, showing an image, playing music, producing sounds, producing a voice response, providing a haptic experience, producing a vibration, saving information, purchasing products, sharing information, reserving products, clicking, pressing, tapping, swiping, gesturing, voice commanding.

10. The interactive multimedia management system according to claim 1, wherein said media of interest comprises at least one of: an item, an object, a person, an animal, a place, a company, music, a sound, a phrase, a location, a scene, a credit, a product, a service, an advertisement, a brand.

11. The interactive multimedia management system according to claim 1, wherein said media of interest is provided as at least one of: an audio file, an image file, a video file, a URL, a hyperlink, image data, video data, audio data, textual data, metadata, numerical data, symbols, program coding language, an audio/visual/sensory representation thereof.

12. The interactive multimedia management system according to claim 1, wherein said media associated to said user device comprises at least one: media representative of content external from said user device or media representative of content internal to said user device.

13. The interactive multimedia management system according to claim 12, wherein said media representative of content external from said user device comprises at least one of: image data, video data, audio data, textual data, metadata, numerical data, symbols, program coding language, or an audio/visual/sensory representation.

14. The interactive multimedia management system according to claim 12, wherein said media representative of content external from said user device is provided as at least one of: an image, an illustration, a video, audio, music, a photo, a movie, a music video, a commercial, a web series, a TV show, a documentary, a banner, clothing, an object, a structure, art, an audio book, a computer game, a video game, software, an advertisement, signage, a virtual reality content, an augmented reality content, a mixed reality content, interactive content, a live performance, a sporting event or a theatrical play.

15. The interactive multimedia management system according to claim 12, wherein said media representative of content internal to said user device comprises at least one of: image data, video data, audio data, textual data, metadata, numerical data, symbols, program coding language, or an audio/visual/sensory representation.

16. The interactive multimedia management system according to claim 12, wherein said media representative of content internal from said user device is provided as at least one of: an image, an illustration, a video, audio, music, a photo, a movie, a music video, a commercial, a web series, a TV show, a documentary, a banner, clothing, an object, a structure, art, an audio book, a computer game, a video game, software, an advertisement, signage, a virtual reality content, an augmented reality content, a mixed reality content, interactive content, a live performance, a sporting event or a theatrical play.

17. The interactive multimedia management system according to claim 1, wherein said single access interaction request is generated independent of said interaction response based on at least one of: an independent exported content, a designated outcome or a designated selection, stored on said server database.

18. The interactive multimedia management system according to claim 1, wherein said user device comprises at least one of: a smartphone, tablet, laptop computer, desktop computer, television display, monitor, virtual reality (VR) equipment, augmented reality (AR) equipment, glasses, lenses, neural device, smartwatch, computing device or electronic device.

19. The interactive multimedia management system according to claim 18, wherein said user device is configured to at least one of: read, detect, sense, capture, receive, interpret or respond to content outside and within said user device and to further send related information to an application running on said user device, running outside said user device or a combination thereof.

20. The interactive multimedia management system according to claim 18, wherein said user device is configured to at least one of: display, play, project, emit, execute, read, detect, sense, capture, receive, identify, interpret or respond to content within the user device and to further send related information to an application running on said user device, running outside said user device or a combination thereof.

21. The interactive multimedia management system according to claim 1, further comprising a marketplace/e-commerce module implemented within said single access module, external to said single access module or a combination thereof.

22. The interactive multimedia management system according to claim 1, further comprising an application running on said user device, running outside said user device or a combination thereof, wherein the interaction request and the single access interaction request are generated by said application and the interaction response and the single access interaction response are received at said application.

23. The interactive multimedia management system according to claim 22, wherein said single access module receives from said application at least one single access interaction request in order to generate a list of items of interest to the user which are associated to said at least one single access interaction request.

24. The interactive multimedia management system according to claim 23, wherein the list containing the items of interest are conveyed to the user at least one of: at the time of generating said at least one single access interaction request or at a later time.

25. The interactive multimedia management system according to claim 23, further comprising a marketplace/e-commerce module providing to said application a merchant platform to buy and sell goods and services based on the items contained on said list.

26. The interactive multimedia management system according to claim 1, wherein said reference tool module comprises an analytics module configured to retrieve and analyze collected data from said server database and convey said data to users of the reference tool module.

27. A method for enhancing an interactive multimedia experience to a user comprising:
receiving at a reference tool module, media of interest from a content provider and generating reference content associated to said media of interest, detailed information related to said reference content and at least one outcome associated to the reference content;
receiving at a single access module said reference content, said detailed information and said at least one outcome for storage on a server database;
receiving at an interaction server module an interaction request including media associated to a user device;
comparing the media associated to said user device with the reference content on said server database;
sending to the user device from said interaction server module an interaction response when said reference content is matched to content on the media associated to said user device; and
receiving at the single access module a single access interaction request from said user device based on said interaction response and sending to said user device a single access interaction response from the single access module based on said single access interaction request.

28. The method according to claim 27, wherein selecting the content from the media of interest and generating said reference content is performed by a selection module of said reference tool module.

29. The method according to claim 28, further comprising selecting said content automatically by an automatic selection module, manually by the content provider or a combination thereof.

30. The method according to claim 29, further comprising manually deselecting the automatically selected content via the selection module.

31. The method according to claim 27, wherein said detailed information and said at least one outcome are generated by a designation module on said reference tool.

32. The method according to claim 27, wherein the interaction response sent to the user device includes at least one of: said detailed information or said at least one outcome.

33. The method according to claim 27, wherein said detailed information comprises at least one of: a product information, a service information, a product specifications, a service specification, a brand, a product name, a service name, a manufacturer name, a model number, a color, a size, a type, a title, a description, keywords, images, prices, a product option, a service option, delivery options, shipping details, payment options, donation options, discount options, offers, promotions, news, locations, biographies, filmographies, videos, movie trailers, behind-the-scenes videos, deleted scenes videos, post-credits scenes video, directors' cuts video, graphics, 2D models, 3D models, animations, audio, music, voice over, vibrations.

34. The method according to claim 27, wherein said detailed information is provided as at least one of: an audio file, an image file, a video file, a URL, a hyperlink, image data, video data, audio data, textual data, metadata, numerical data, symbols, program coding language, an audio/visual/sensory representation thereof.

35. The method according to claim 27, wherein said at least one outcome comprises at least one of: a visual experience, an audio experience, a sensory experience, an augmented reality experience, displaying a video, showing an image, playing music, producing sounds, producing a voice response, providing a haptic experience, producing a vibration, saving information, purchasing products, sharing information, reserving products, clicking, pressing, tapping, swiping, gesturing, voice commanding.

36. The method according to claim 27, wherein said media of interest comprises at least one of: an item, an object, a person, an animal, a place, a company, music, a sound, a phrase, a location, a scene, a credit, a product, a service, an advertisement, a brand.

37. The method according to claim 27, wherein said media of interest is provided as at least one of: an audio file, an image file, a video file, a URL, a hyperlink, image data, video data, audio data, textual data, metadata, numerical data, symbols, program coding language, an audio/visual/sensory representation thereof.

38. The method according to claim 27, wherein said media associated to said user device comprises at least one: media representative of content external from said user device or media representative of content internal to said user device.

39. The method according to claim 38, wherein said media representative of content external from said user device comprises at least one of: image data, video data, audio data, textual data, metadata, numerical data, symbols, program coding language, or an audio/visual/sensory representation.

40. The method according to claim 38, wherein said media representative of content external from said user device is provided as at least one of: an image, an illustration, a video, audio, music, a photo, a movie, a music video, a commercial, a web series, a TV show, a documentary, a banner, clothing, an object, a structure, art, an audio book, a computer game, a video game, software, an advertisement, signage, a virtual reality content, an augmented reality content, a mixed reality content, interactive content, a live performance, a sporting event or a theatrical play.

41. The method according to claim 38, wherein said media representative of content internal to said user device comprises at least one of: image data, video data, audio data, textual data, metadata, numerical data, symbols, program coding language, or an audio/visual/sensory representation.

42. The method according to claim 38, wherein said media representative of content internal from said user device is provided as at least one of: an image, an illustration, a video, audio, music, a photo, a movie, a music video, a commercial, a web series, a TV show, a documentary, a banner, clothing, an object, a structure, art, an audio book, a computer game, a video game, software, an advertisement, signage, a virtual reality content, an augmented reality content, a mixed reality content, interactive content, a live performance, a sporting event or a theatrical play.

43. The method according to claim 27, wherein said single access interaction request is generated independent of said interaction response based on at least one of: an independent exported content, a designated outcome or a designated selection, stored on said server database.

44. The method according to claim 27, wherein said user device comprises at least one of: a smartphone, tablet, laptop computer, desktop computer, television display, monitor, virtual reality (VR) equipment, augmented reality (AR) equipment, glasses, lenses, neural device, smartwatch, computing device or electronic device.

45. The method according to claim 44, wherein said user device is configured to at least one of: read, detect, sense, capture, receive, interpret or respond to content outside and within said user device and to further send related information to an application running on said user device, running outside said user device or a combination thereof.

46. The method according to claim 44, wherein said user device is configured to at least one of: display, play, project, emit, execute, read, detect, sense, capture, receive, identify, interpret or respond to content within the user device and to further send related information to an application running on said user device, running outside said user device or a combination thereof.

47. The method according to claim 27, further comprising providing a marketplace/e-commerce module implemented within said single access module, external to said single access module or a combination thereof.

48. The method according to claim 27, further comprising providing an application running on said user device, running outside said user device or a combination thereof, wherein the interaction request and the single access interaction request are generated by said application and the interaction response and the single access interaction response are received at said application.

49. The method according to claim 48, wherein said single access module receives from said application at least one single access interaction request in order to generate a list of items of interest to the user which are associated to said at least one single access interaction request.

50. The method according to claim 49, wherein the list containing the items of interest are conveyed to the user at least one of: at the time of generating said at least one single access interaction request or at a later time.

51. The method according to claim 49, further comprising providing a marketplace/e-commerce module that provides to said application a merchant platform to buy and sell goods and services based on the items contained on said list.

52. The method according to claim 27, further comprising providing an analytics module retrieving and analyzing collected data from said server database and conveying said data to users of the reference tool module.
